(19) United States
(12) Patent Application Publication
(10) Pub. No.: US 2020/0303757 A1
(43) Pub. Date: Sep. 24, 2020

(54) Mass and Charge Transfer Enhanced Electrode for High-Performance Aqueous Flow Batteries

(71) Applicant: Northeastern University, Boston, MA (US)

(72) Inventor: Hongli Zhu, Arlington, MA (US)

(21) Appl. No.: 16/815,583

(22) Filed: Mar. 11, 2020

Related U.S. Application Data
(60) Provisional application No. 62/820,070, filed on Mar. 18, 2019.

(51) Int. Cl. H01M 8/18; C01B 32/19; H01M 4/88

(52) U.S. Cl. CPC H01M 8/188; H01M 4/8878; C01B 32/19

(57) ABSTRACT

Methods of exfoliating a graphite felt include applying a voltage differential to the graphite felt in an aqueous solution. Typically, the voltage differential is from about 5 V to about 20 V, preferably from about 10 V to about 15 V, and is applied for a duration from about 15 seconds to about 10 minutes, preferably from about 30 seconds to about 2 minutes. The aqueous solution includes a dissolved electrolyte, such as NH⁴⁺ or SO₄²⁻.

### RELATED APPLICATION

This application claims the benefit of U.S. Provisional Application No. 62/820,070, filed on Mar. 18, 2019. The entire teachings of the above application are incorporated herein by reference.

### BACKGROUND

Electricity generated from renewable sources, such solar and wind, is intermittent. One approach to mitigate this differing patterns of energy generation and utilization is integration of an energy storage system.² Redox flow batteries (RFB) are regarded as one of the most promising large-scale energy storage technologies. One of the core components of the RFB stack is an electrode, which to a certain extent governs the overall performance of the RFB as reactions occur at the electrode's surface.

### SUMMARY

Fabrication of a high-performance electrode with enhanced charge and mass transfer on a large scale and in an efficient way remains a significant challenge in flow batteries. Described herein is a scalable surface modification method of a graphite felt (GF) electrode based on controlled electrochemical exfoliation to enhance the mass and charge transfer of the electrode. In particular embodiments, exfoliation of the GF was conducted in ammonium sulfate (((NH)₄)₂SO₄) aqueous solution by breaking weak van der Waals forces between graphitic layers through anion intercalation at room temperature with one minute. Consequently, the exfoliation introduced sufficient oxygen functional groups resulting in enhanced reaction kinetics at the electrode-electrolyte interface and improved hydrophilicity, thereby enabling better electrolyte accessibility. Further, spin-polarized density functional theory was also employed to reveal the role of introduced oxygen functional groups in accelerating the vanadium redox reaction. Benefitting from the sufficient oxygen groups and superior wettability, the as-prepared exfoliated GF (E-GF) shows improved electrocatalytic activity with minimized overpotential, higher volumetric capacity, and improved energy efficiency. A redox flow battery (RFB) assembled with the E-GF electrode delivered a voltage efficiency of 73%, an energy efficiency of 70%, and 56% higher capacity retention compared to a thermally treated sample after 100 cycles at a high current density of 100 mA cm⁻². Remarkably, elimination of the high-temperature, energy consuming, and time-consuming synthesis processes makes the approach described herein much more energy and time efficient, scalable, and lower cost compared to the traditional (thermal) GF treatment method.

Described herein is a scalable approach for fabricating a unique hierarchical core-shell framework of graphite fibers by treating the GF using a controlled electrochemical exfoliation. In one embodiment, the exfoliation was conducted in 0.1 M ammonium sulfate solution by applying 10 V positive bias voltage. Without wishing to be bound by theory, at the first step of the exfoliation process, active nucleophile hydroxyl ions (OH⁻) are generated from the electrolysis of water and initially attack the graphite fibers at the edge sites and grain boundaries leading to depolarization and expansion of the graphite layers. The expanded graphite layers facilitate the intercalation of water (H₂O) molecules and sulfate anions (SO₄²−) in between the layers, where the SO₄²⁻ reduces to sulfur dioxide (SO₂) and the H₂O molecule oxidizes to oxygen (O₂) causing gas evolution.²⁵ These produced gasses exert forces toward the much weaker van der Waals bonding between the layers triggering the exfoliation of the graphite fibers. In addition, the unique hierarchical core-shell architecture contains abundant surface oxygen groups that simultaneously behave as active sites for the redox reactions and promote electron and ion transportation, which are critical requirements of an electrode in the RFB.

The methods described herein provide a number of advantages. The process can be performed in minutes, which is much shorter than existing treatments that take 10-30 hours. Traditional modification methods to enhance electrochemical activity involve high-temperature treatments, which consumes a significant amount of energy. The proposed method for treating graphite felt can be performed at room temperature and does not involve any high-temperature treatment, and therefore is much more energy efficient. The exfoliation can be carried out in an environmentally friendly aqueous solution with effortless setup, and hence, can be readily scaled up, unlike the traditional treatments. The resulting exfoliated graphite felt has a unique layered structure and abundant surface oxygen groups.

Described herein are methods for exfoliating a graphite felt. The methods can include applying a voltage differential to the graphite felt in an aqueous solution, thereby forming an exfoliated graphite felt. The voltage differential can be from about 5 V to about 20 V and can be applied for a duration from about 15 seconds to about 10 minutes. The aqueous solution can include a dissolved electrolyte.

In some embodiments, the dissolved electrolyte includes SO₄²⁻ ions. In some embodiments, the dissolved electrolyte includes NH₄⁺ ions. In some embodiments, the dissolved electrolyte includes SO₄²⁻ ions and NH₄⁺ ions. In some embodiments, the method includes dissolving ammonium sulfate (((NH)₄)₂SO₄) to form the dissolved electrolyte. In some embodiments, the concentration of dissolved ammonium sulfate is from about 0.1 M to about 0.5 M. In some embodiments, the concentration of dissolved ammonium sulfate is about 0.1 M.

In some embodiments, the dissolved electrolyte includes one or more of NO₃⁻ ions, SO₃²⁻ ions, and CO₃²⁻ ions. In some embodiments, the method includes dissolving one or more of (NH₄)₂SO₃, Na₂CO₃, NaNO₃.

In some embodiments, the voltage differential is from about 10 V to about 15 V. In some embodiments, the voltage differential is about 10 V. In some embodiments, the voltage differential is applied for a duration from about 30 seconds to 4 minutes. In some embodiments, the voltage differential is applied for a duration from about 30 seconds to 2 minutes. In some embodiments, the voltage differential is applied for a duration from about 30 seconds to about 90 seconds. In some embodiments, the voltage differential is applied for a duration of about 60 seconds. In some embodiments, the voltage differential is a positive voltage differential. In some embodiments, applying a voltage differential graphite felt includes applying the voltage differential to a roller that contacts the graphite felt.

Described herein are exfoliated graphite felts. In some embodiments, the exfoliated graphite felt exhibits an aqueous contact angle from about 0 degrees to about 10 degrees. In some embodiments, the exfoliated graphite felt has a surface oxygen content of at least 20% as determined by X-ray photoelectron spectroscopy. In some embodiments, the exfoliated graphite felt has a surface oxygen content from about 20% to about 25% as determined by X-ray photoelectron spectroscopy. In some embodiments, the exfoliated graphite felt has an oxygen-to-carbon ratio of at least 0.3 as determined by X-ray photoelectron spectroscopy. In some embodiments, the exfoliated graphite felt has an oxygen-to-carbon ratio from 0.25 to 0.375 as determined by X-ray photoelectron spectroscopy.

Described herein is a flow battery that includes an electrode, an electrolyte, and a battery, wherein the electrode includes an exfoliated graphite felt formed according to the methods described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a schematic illustration of an exfoliation mechanism showing the anion intercalation and subsequent reduction leading to expanded graphite layers. FIG. 1B is a schematic illustration of core-shell fiber morphology showing the solid core and the exfoliated surface (shell). FIG. 1C is a schematic illustration of application of the exfoliated GF electrode on both positive and negative sides in a redox flow battery. FIG. 1D is a schematic illustration of the large-scale roll to roll manufacturing of the exfoliated GF for industrial manufacturing.

FIGS. 2A-E are characterizations of E-GF electrode compared to the pristine GF. FIG. 2A: Digital photographs of GF before and after exfoliation. Contact angle measurement of pristine GF (FIG. 2B) and E-GF electrode (FIG. 2C). SEM images of pristine GF (FIG. 2D) and E-GF (FIG. 2E) at different magnifications of 1 K, 10 K, and 100 K.

FIGS. 3A-F show electrochemical analysis of the prepared E-GF electrode (exfoliated for 1 min) compared to pristine GF, A-GF, and T-GF in 0.1 M VOSO₄ in 3 M H₂SO₄. CV curves of E-GF electrode compared to the pristine GF, A-GF, and T-GF for VO₂⁺/VO²⁺ (FIG. 3A) and V³⁺/V²⁺ (FIG. 3B) redox couples at 1 mV s⁻¹ scan rate. CV curves of E-GF electrode at various scan rates ranging from 1 to 10 mV s⁻¹ for VO₂⁺/VO²⁺ (FIG. 3C) and V³⁺/V²⁺ (FIG. 3D) redox couples. The plot of anodic (I_{Pa}) and cathodic (I_{Pc}) peak currents of E-GF electrodes versus the square root of the scan rates for VO₂⁺/VO²⁺ (FIG. 3E) and V³⁺/V²⁺ (FIG. 3F) redox couples.

FIGS. 4A-B are high-resolution XPS spectra of pristine and exfoliated graphite felt for C is (FIG. 4A) and O is (FIG. 4B). FIG. 4C is Raman spectra for pristine, acid treated, thermally treated, and exfoliated graphite felt. FIG. 4D is XRD spectra for pristine, acid treated, thermally treated, and exfoliated graphite felt.

FIGS. 5A-G shows electrochemical performance of vanadium redox flow batteries (VRFB) employing E-GF electrodes exfoliated for 30 sec, 1 min, and 2 min. FIG. 5A: Nyquist plots of E-GF electrodes treated for 30 sec, 1 min, and 2 min. FIG. 5B: Fitted polarization curves are highlighting the slopes of the curves for charge and discharge that represents the ASR. FIG. 5C: Charge-discharge profiles of E-GF electrodes at 40 mA cm⁻². FIG. 5D: Coulombic efficiency of E-GF electrodes at current densities of 40, 60, 80, 100, 150, and 200 mA cm⁻² . FIG. 5E: Voltage efficiency of E-GF electrodes at current densities of 40, 60, 80, 100, 150, and 200 mA cm⁻². FIG. 5F: Energy efficiency of E-GF electrodes at current densities of 40, 60, 80, 100, 150, and 200 mA cm⁻². FIG. 5G: Rate Performance of E-GF electrodes at current densities of 40, 60, 80, 100, 150, and 200 mA cm⁻².

FIGS. 6A-I shows electrochemical performance of VRFB employing pristine GF, A-GF, T-GF, and E-GF electrodes. FIG. 6A: Nyquist plots pristine GF, A-GF, T-GF, and E-GF electrodes. FIG. 6B: Fitted polarization curves of pristine GF, A-GF, T-GF, and E-GF electrodes. FIG. 6C: Charge-discharge profiles of pristine GF, A-GF, T-GF, and E-GF electrodes at 40 mA cm⁻². FIG. 6D: Charge-discharge profiles of E-GF electrodes at current densities of 40, 60, 80, 100, 150, and 200 mA cm⁻². FIG. 6E: Rate Performance of pristine GF, A-GF, T-GF, and E-GF electrodes at different current densities of 40, 60, 80, 100, 150, and 200 mA cm⁻². FIG. 6F: CE of A-GF, T-GF, and E-GF electrodes at different current densities (40, 60, 80, 100, 150, and 200 mA cm⁻²). FIG. 6G: VE of A-GF, T-GF, and E-GF electrodes at different current densities (40, 60, 80, 100, 150, and 200 mA cm⁻²). FIG. 6H EE of A-GF, T-GF, and E-GF electrodes at different current densities (40, 60, 80, 100, 150, and 200 mA cm⁻²). FIG. 6I: Cycling stability representing the discharge capacity and CE of E-GF electrode compared to T-GF electrode for 100 continuous charge-discharge cycling at 100 mA cm⁻².

FIG. 7A is CV curves of E-GF electrodes exfoliated for various times ranging from 0 sec to 4 min for VO₂⁺/VO²⁺ and V³⁺/V²⁺ redox couples. FIG. 7B is CV curves of 1 min E-GF electrodes exfoliated in various electrolyte solutions.

FIG. 8A is CV curves of T-GF electrode at different scan rates ranging from 1 to 10 mV s⁻¹ for VO₂⁺/VO²⁺ redox couple. FIG. 8B is CV curves of A-GF electrode at different scan rates ranging from 1 to 10 mV s⁻¹ for VO₂⁺/VO²⁺ redox couple. FIG. 8C is CV curves of T-GF electrode at different scan rates ranging from 1 to 10 mV s⁻¹ for V³⁺/V²⁺ redox couple. FIG. 8D is CV curves of A-GF electrode at different scan rates ranging from 1 to 10 mV s⁻¹ for V³⁺/V²+ redox couple.

FIG. 9 is 1^{st} and 2^{nd} cycle of the cyclic voltammetry curves of exfoliated 1 min exfoliated graphite felt electrode in 0.1 M VOSO₄ in 3 M H₂SO₄ for the VO⁺/VO²⁺ redox couple at different scan rates ranging from 1 mV s⁻¹ to 10 mV s⁻¹.

FIG. 10 is cyclic voltammetry curves of the pristine, thermally treated, acid treated, and exfoliated graphite felt electrode in 0.1 M VOSO₄ in 3 M H₂SO₄ for the VO₂⁺/VO²⁺ redox couple at 1 mV s⁻¹ exhibiting the critical parameters such as redox onset potential for oxidation and reduction and peak potential separation (ΔE).

FIG. 11 is wide range XPS spectra of pristine and exfoliated graphite felt.

FIG. 12 is high-resolution XPS spectra of pristine and exfoliated graphite felt for (a) N 1s (b) S 2p.

FIG. 13 is XRD of the peeled off surface of the E-GF electrode compared to the pristine GF.

FIGS. 14A-C are Nyquist plots of VRFB employing E-GF electrodes exfoliated for various times ranging from 0 sec to 2 min. FIG. 14A: Original plot. FIG. 14B: Zoomed in part of FIG. 14A. FIG. 14C Zoomed in part of FIG. 14B to show the semicircles. The symbols represent the measured data and the line represent the corresponding fitting.

FIGS. 15A-B are charge-discharge profiles of E-GF electrodes exfoliated for 30 sec (FIG. 15A) and 2 min (FIG. 15B) at current densities of 40, 60, 80, 100, 150, and 200 mA cm⁻².

FIGS. 16A-C are Nyquist plots of VRFB employing E-GF electrodes exfoliated for various times ranging from 0 sec to 2 min. FIG. 16A: Original plot. FIG. 16B: Zoomed in part of FIG. 16A. FIG. 16C: Zoomed in part of FIG. 16B to show the semicircles. The symbols represent the measured data and the line represent the corresponding fitting.

FIG. 17 is a schematic showing charge density difference between neutral and +1/−1 charged OH and H terminated graphene.

### DETAILED DESCRIPTION

A description of example embodiments follows.

Introduction

The increasing amount of electricity generated from two of the most rapidly growing, green, and sustainable forms of renewable energy, solar and wind, account for the most significant share of renewables due to their abundance.¹ However, the challenge lies in their inherent intermittency, and one approach to mitigate this discrepancy between the energy generation and utilization is the integration of an energy storage system.² Redox flow batteries (RFB) are regarded as one of the most promising large-scale energy storage technologies owing to their ability to independently scale energy and power density to meet specific applications due to their unique flow-based architecture. One of the core components of the RFB stack is the electrode, which to a certain extent governs the overall performance of the RFB as the reaction occurs at the electrode surface. In a flow battery, increasing the operating current density to increase the power density and energy efficiency is one of the most effective ways to reduce the stack size, which in turn can reduce the cost.¹ Importantly, increasing the current density would indeed increase the voltage loss arising from the polarization that includes electrode kinetics, ohmic resistance, and mass transport limitations, leading to undesirable deterioration in the overall cell performance.² The ohmic resistance and the charge transfer polarization strongly depends on the physiochemical properties of the electrodes in the RFBs. The most commonly used electrodes in RFB are graphite felts (GF) and carbon felts (CF) by virtue of their high electrical conductivity, excellent stability, high corrosion resistance, and broad operational potential at a reasonable cost.³ Despite the intensive research efforts, achieving high power density and energy efficiency is still a significant challenge for the RFB due to the hydrophobic nature arising from the high-temperature graphitization limiting the electrolyte diffusion, poor catalytic activity contributing to higher polarization losses, and lack of abundant active sites owing to the low specific surface area.⁴

One effective way to enhance the electrocatalytic activity and thereby energy efficiency and power density is to deposit precious noble metals, such as Pt, Ru, Au, Bi, and Ir, but their high cost and higher hydrogen evolution rate hinder the large-scale commercialization.⁵ Alternatively, low-cost metal oxides such as ZrO₂,⁶ Mn₃O₄,⁷ WO₃,⁸ TiO₂,⁹ CeO₂¹⁰, PbO₂,¹¹, Ta₂O₅,¹² Nd₂O₃,¹³, and Nb₂O₅¹⁴ have also been deposited on the GF to enhance the electrocatalytic activity. However, several critical parameters like their nanosize, uniform distribution, structural stability in the harsh vanadium redox flow batteries (VRFB) environment, and stability against dissolution severely affect the activity of the metal oxide catalysts. Recently, carbonaceous catalysts such as graphene,¹⁵ graphene oxide,¹⁶ single-walled carbon nanotubes,¹⁷ multiwalled carbon nanotubes¹⁸ were used to promote the electrochemical activity due to their unique physical and chemical properties facilitating high specific surface area and adequate reaction sites. However, the extensive utilization of graphene and carbon nanotube-based catalyst is not practical considering their high cost, the requirement of a sacrificial metal, and rigorous reaction conditions. Other effective strategies like doping heteroatoms (nitrogen¹⁹ and phosate²⁰, boron²¹), surface modification to introduce carboxylic and hydroxyl groups²², activation in the CO₂ environment, wet etching using KOH to generate micropores,²³ and repeated NiO/Ni redox reaction to create graphenated graphite surface²⁴ have also been implemented to accelerate the reaction kinetics. Nonetheless, the significant obstacles to the cost-effective industrial-scale application of the modified GF are the requirement of high-temperature processing and tedious fabrication process. Therefore, a low cost, facile, and scalable approach to introduce adequate functional groups and enhance the wettability is desirable.

Described herein is a scalable approach to fabricate a unique hierarchical core-shell framework of graphite fibers by treating the GF using a controlled electrochemical exfoliation. In one embodiment, the exfoliation was conducted in 0.1 M ((NH)₄)₂SO₄ solution by applying 10 V positive bias voltage. The exfoliated graphite felt produced by the process has a distinct surface modification that is rich in oxygen groups, which (1) enhances the wettability leading to better electrolyte penetration and ion diffusion, (2) provides an adequate number of reaction sites, and (3) accelerate the electron and ion transportation by increasing the local charge concentration. Notably, the strong synergistic effect from high conductivity and the surface oxygen groups endow the E-GF electrode with excellent electrochemical activity resulting in high energy efficiency of 70% and about 56% greater capacity retention in a flow cell while operating at a high current density of 100 mA cm⁻². More importantly, due to the fast and room temperature modification of the E-GF electrode in aqueous solution, the entire process is rapid, environmentally friendly, energy efficient, low cost, and can be scaled up to for large-scale roll-to-roll manufacturing as an electrode treatment for various electrodes.

Graphite Felt

Graphite is a crystalline form of carbon having atoms arranged in layers of hexagonal structures. Graphite is not a metal, but its high conductivity makes it a useful material for an electrode. Most graphite felt materials are rayon-based or polyacrylnitrile-based (PAN).

Graphite felt has graphite fibers. A graphite felt typically has a thickness ranging from about 0.25 inches to about 0.50 inches, though other thicknesses can be used.

Many graphite felts are commercially available and are suitable for use in the methods described herein.

Exfoliation of Graphite Felt

Graphite felt is exfoliated by placing the graphite felt in an aqueous solution, where the pristine graphite felt is used as both cathode and anode. The aqueous solution has an electrolyte dissolved therein, such as ammonium sulfate (((NH)₄)₂SO₄). Other electrolytes include (NH₄)₂SO₃, Na₂CO₃, NaNO₃.

A voltage differential is applied to the electrode. Typically, the voltage differential can range from about 5 V to about 20 V, preferably from about 10 V to about 15 V, even more preferably about 10 V.

The voltage differential is applied for a duration of time. The voltage differential can be applied for a duration from about 15 seconds to about 10 minutes, preferably from about 30 seconds to about 4 minutes, even more preferably from about 30 seconds to about 2 minutes. In some embodiments, the voltage differential is applied for a duration from about 30 seconds to about 90 seconds. In some embodiments, the voltage differential is applied for a duration of about 60 seconds.

The term “positive voltage” is used herein for convenience and should be understood that it is an example of a voltage differential relative to a ground or return voltage.

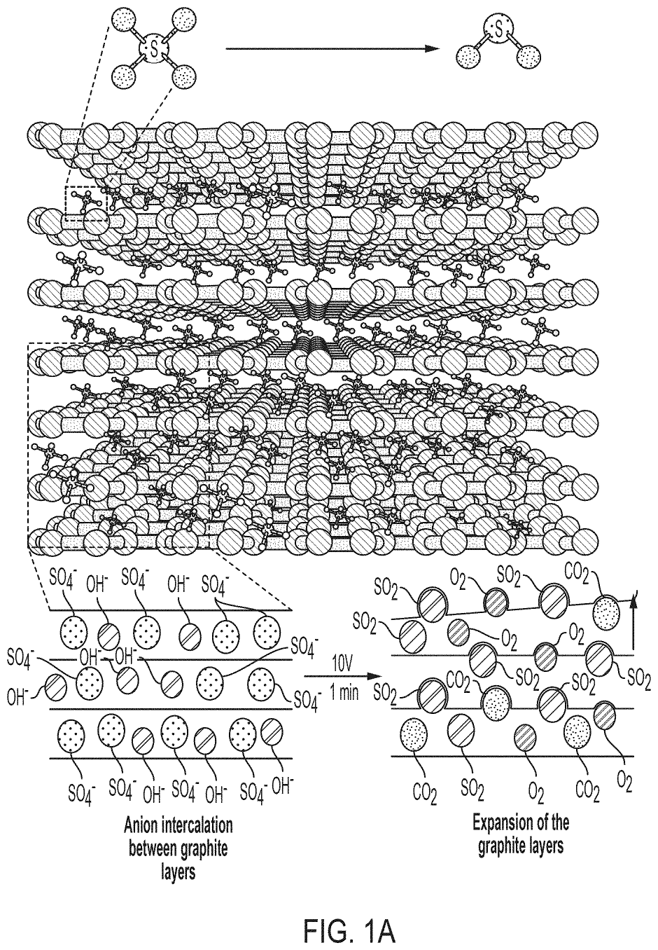

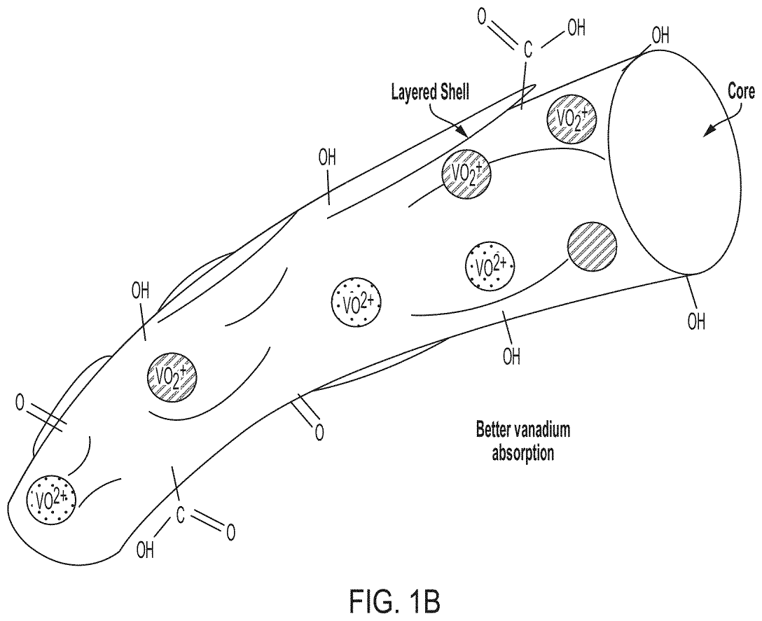

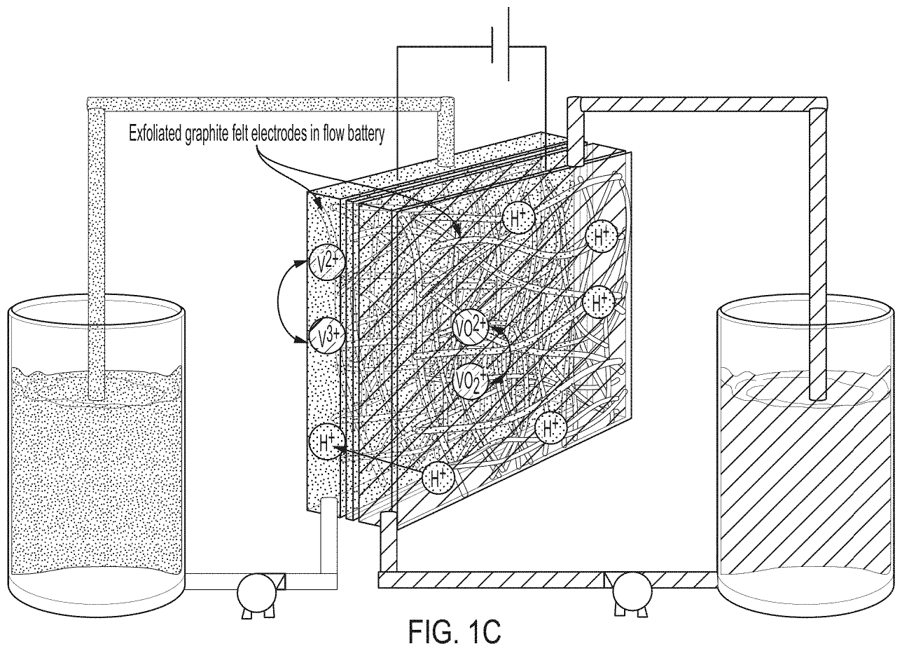

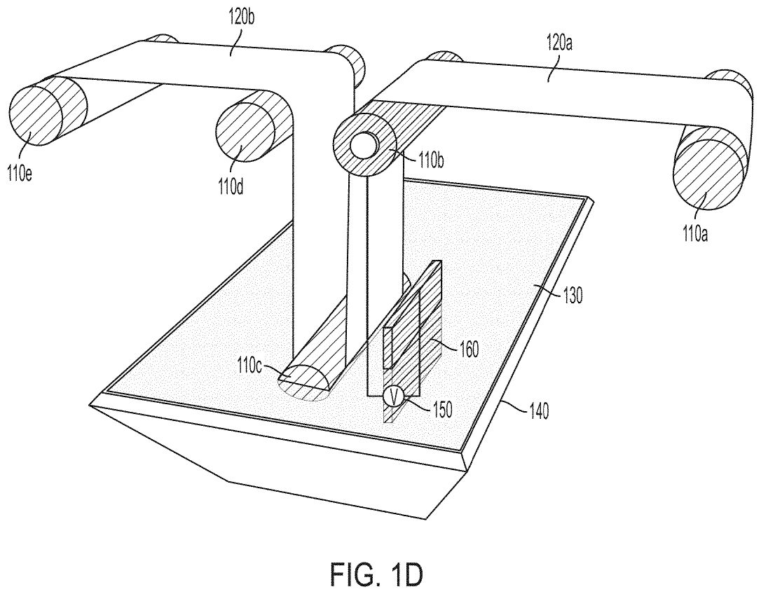

FIG. 1D is a schematic illustration of roll to roll manufacturing of an exfoliated graphite felt. Graphite felt 120a is wound around a plurality of rollers 110a-e, beginning at roller 110a. At least one tension roller 110c is at least partially submerged within an aqueous solution 130 within a container 140. A voltage source 150 is electrically connected to roller 110b and counter electrode 160, which is at least partially submerged within the aqueous solution 130. The voltage source 150 applies a voltage differential to roller 110b, for example, a positive voltage differential relative to the counter electrode. Exfoliated graphite felt 120b is collected on roller 110e.

### EXEMPLIFICATION

### Results and Discussion

The exfoliation was carried out in a two electrode system in an aqueous solution containing 0.1 M ((NH₄)₂SO₄) by applying a positive DC bias of 10 V to the GF anode. Without wishing to be bound by theory, at the first step of the exfoliation process, hydroxyl (OH•) and oxygen (O•) radicals are generated from the dissociation of water as the voltage applied surpasses the narrow electrochemical potential window of water.²⁵ Initially, these radicals attack the graphite fibers and oxidation or hydroxylation occurs at the edge sites and grain boundaries. As a result the defective sites present at the edge or grain boundaries open up²⁶ leading to depolarization and expansion of the graphite layers. The expanded graphite layers facilitate the intercalation of water (H₂O) molecules and sulfate anions (SO₄²⁻) in between the layers, where the SO₄²⁻ reduces to sulfur dioxide (SO₂) and the H₂O molecule oxidizes to oxygen (O₂) causing gas evolution.²⁷ These produced gasses exert forces towards the much weaker van der Waals bonding between the layers triggering the exfoliation of the graphite fibers, as illustrated in FIG. 1A. In addition to the oxidation of graphite, other reactions may also occur, including evolution of CO₂, which also assists in the exfoliation of the graphite layers. As a result, a core-shell fiber morphology (FIG. 1B) containing a solid core and a layered surface layer (shell), which increases the hydrophilicity, is formed. In addition, the unique hierarchical core-shell architecture contains abundant surface oxygen groups that simultaneously behave as the active sites for the redox reactions and promote electron and ion transportation, which are the critical requirements of an electrode in the RFB.

The surface modified E-GF sample, possessing a hierarchical core-shell architecture, can be directly used as the electrode in the VRFB and other aqueous RFB. As shown in FIG. 1C, the flow battery performance can be dramatically improved due to the achieved structural complexity of the core-shell fiber framework, which facilitates electron and ion transportation leading to enhanced electrochemical performance. Remarkably, this approach of modifying the GF electrode can readily be scaled up for industrial scale roll to roll manufacturing as it only takes 1 min to exfoliate the GF. FIG. 1D illustrates roll-to-roll exfoliation of GF to obtain super hydrophilic and electrocatalytically active E-GF electrodes.

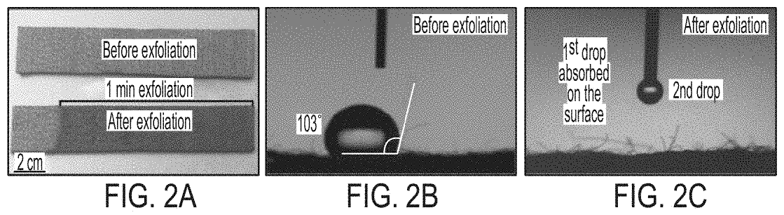

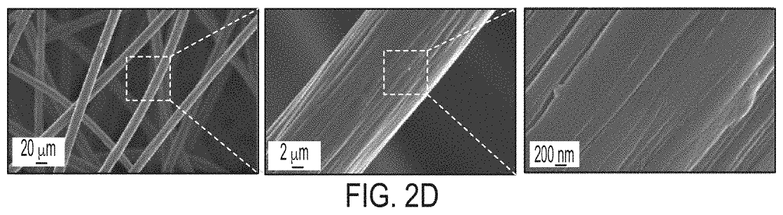

Uniform and controlled exfoliation of the GF sample is crucial for obtaining a homogenous, well organized, and highly conductive core-shell configuration, as well as to prevent total disintegration of the GF structure and therefore maintain structural stability. In FIG. 2A, it is apparent that the color of the surface modified E-GF sample transformed uniformly throughout its entire length of exfoliation suggesting a homogenous treatment. Besides, after exfoliation, the GF very well retains its structural integrity and robustness that verifies that the exfoliation occurs in a controlled manner. Further, to investigate the changes in wettability due to the exfoliation treatment, contact angles were measured for the pristine GF and E-GF, as shown in FIGS. 2B and 2C. The contact angle of pristine GF was measured to be 103°, whereas, it was difficult to measure the contact angle of E-GF as the water was absorbed by the felt instantaneously indicating that the nature of the E-GF changed from hydrophobic to superhydrophilic due to the introduction of the surface oxygen groups. Similar results for the contact angle measurements were obtained when the exfoliation time was varied from 30 secs to 4 min. The result implies that the E-GF contains sufficient oxygen groups due to the positive bias voltage making the felt super-hydrophilic. This excellent hydrophilicity will boost the electrolyte accessibility, accelerate the ion diffusion, and thereby reduce the charge transfer resistance of the electrode and increase the reversibility of the redox reactions.²⁸

Further, the morphologies of the pristine GF and E-GF were investigated by scanning electron microscope (SEM) at different magnifications. FIG. 2D depicts the SEM images of the surface of pristine GF at different magnifications showing a very smooth surface with very few defects and closely packed graphite layers. While a well organized core-shell morphology with evenly spaced layered shell, arising from the expanded graphite layers at the outer surface, is prominent in the SEM images of E-GF electrodes at different magnifications (FIG. 2E). These changes in the morphology are due to the expansion of the edge and grain boundaries of the GF initiating expansion of the graphite layers. Without wishing to be bound by theory, the expanded layers of graphite facilitate anion intercalation and consequently lead to a unique layered structure, which promotes faster ion and electron transportation and benefits the electrochemical activity of the vanadium redox couples by increasing the number of active sites on the surface.

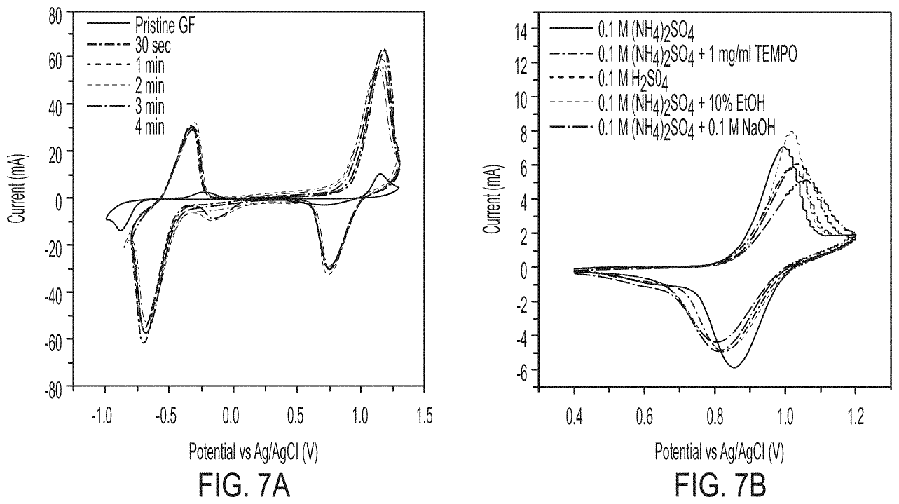

To optimize the exfoliation process, a systematic study was conducted, where a constant bias voltage was applied to the GF electrodes for different time periods (30 secs to 4 min), and the variation in cyclic voltammetry (CV) curves for positive (VO₂⁺/VO²⁺) and negative (V³⁺/V²) electrolytes were examined for the various exfoliation times. Several critical parameters such as the redox onset potential, peak potential separation (ΔE), and the ratio of the peak cathodic (I_{Pc}) and anodic (I_{Pa}) currents were evaluated in a three-electrode system to fundamentally understand the electrocatalytic activity of different E-GF electrodes for VO₂⁺/VO²⁺ and V³⁺/V²⁺ redox couples. The E-GF electrode exfoliated for 1 min has shown the optimal redox onset potentials, lowest ΔE, and highest −I_{Pc}/I_{Pa} ratio, suggesting that the exfoliation time of 1 min provides the best performance compared to the exfoliation time of 30 secs, 2 min, 3 min, and 4 min (FIG. 7A). The optimum performance of the 1 min E-GF electrode is because a considerable amount of graphite flakes were exfoliated and released into the electrolyte solution, when the exfoliation time was increased beyond 1 min. Also, the edge of the graphite expands ten times than its initial state after 1 min due to the vigorous gas evolution leading to excessive swelling of the graphitic layers.²⁷

Moreover, in addition to the ((NH₄)₂SO₄) solution, various aqueous electrolyte solutions including 0.1 M ((NH₄)₂SO₄) with TEMPO [(2,2,6,6-tetramethylpiperidin-1-yl)oxyl], 0.1 M ((NH₄)₂SO₄) with 10% ethanol, 0.1 M ((NH₄)₂SO₄) with 0.1 M sodium hydroxide (NaOH), and 0.1 M sulfuric acid (H₂SO₄) were used to prepare 1 min E-GF electrodes and their CV curves were examined, where the 0.1 M ((NH)₄)₂SO₄ exhibited best performance (FIG. 7B) among the others. Thus, the CV curves of the E-GF electrodes prepared by applying a positive 10 V DC voltage to the GF anode in 0.1 M ((NH)₄)₂SO₄ aqueous solution for 1 min were used to compare with the pristine GF, and other commonly used modifications of electrodes such as acid treated GF (A-GF) and thermally treated GF (T-GF).

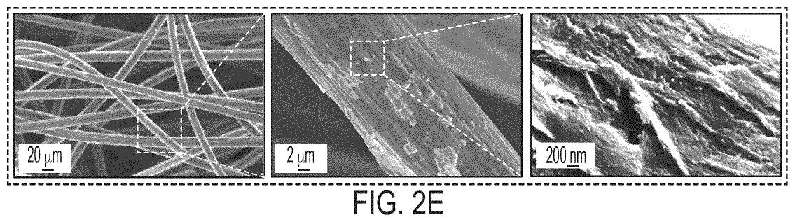

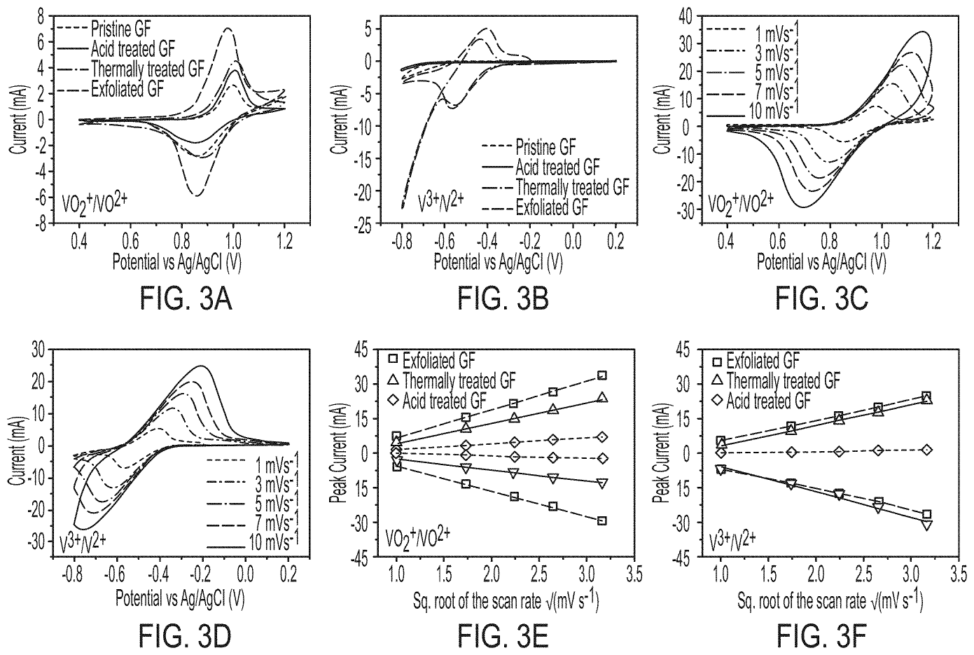

Further, the CV curves (FIGS. 3A-D) of the various GF electrodes evidence substantial enhancement in the electrochemical properties of the as-prepared E-GF compared to the pristine GF, A-GF, and T-GF. In the CV curves of positive electrolyte (VO₂⁺/VO²⁺ redox couples), as depicted in FIG. 3A, the E-GF electrode exhibited significantly better redox onset potentials, a ΔE of 124 mV, and −I_{Pc}/I_{Pa} ratio of q respectively. More importantly, the E-GF electrode displayed more striking effect of accelerating the sluggish kinetics of V³⁺/V²⁺ redox couple demonstrated by clearly defined redox peaks with better redox onset potentials (potential at which the reduction is started)²⁹, a ΔE of 160 mV, and −I_{Pc}/I_{Pa} ratio of 1.44, whereas, no defined redox peaks were obtained for the pristine GF and A-GF (FIG. 3B). In addition, significant undesirable hydrogen evolution reaction (HER) was observed within the working potential window on the T-GF electrode, which will cause an eventual capacity fade in the flow cell.

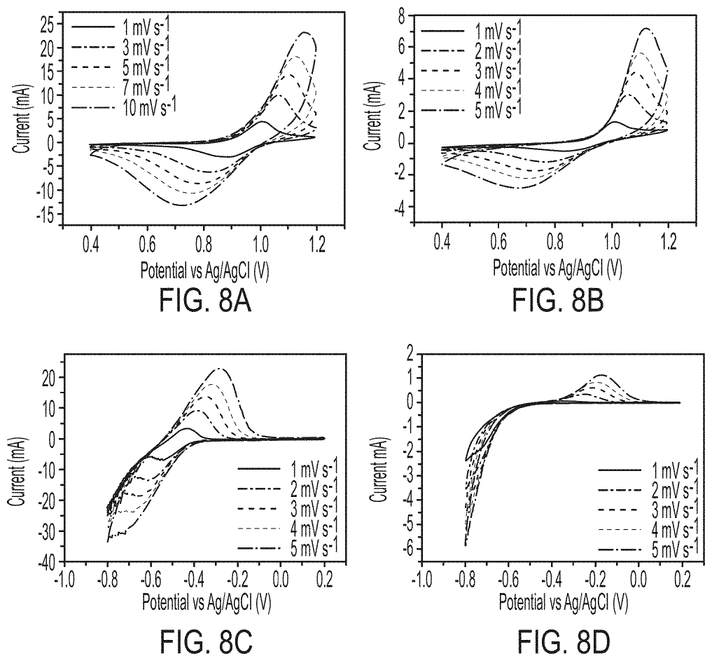

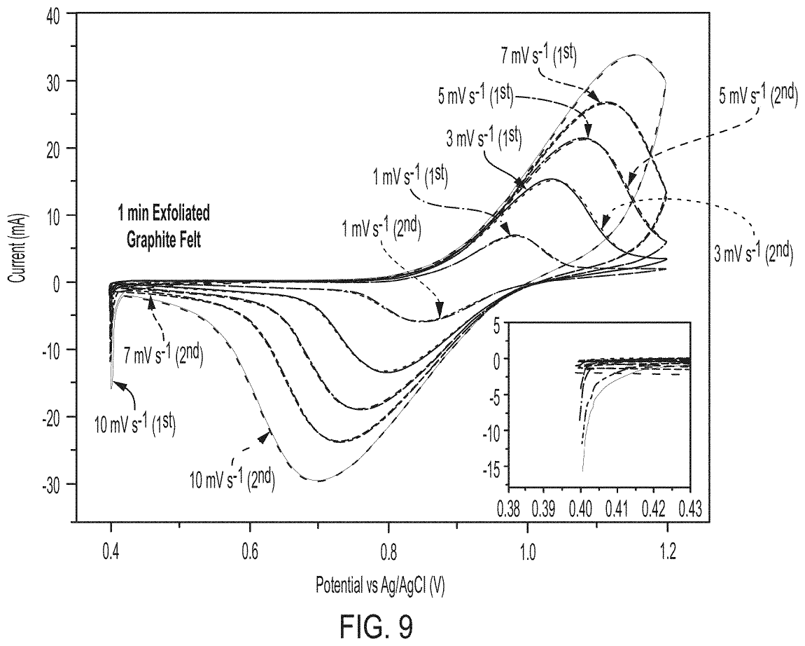

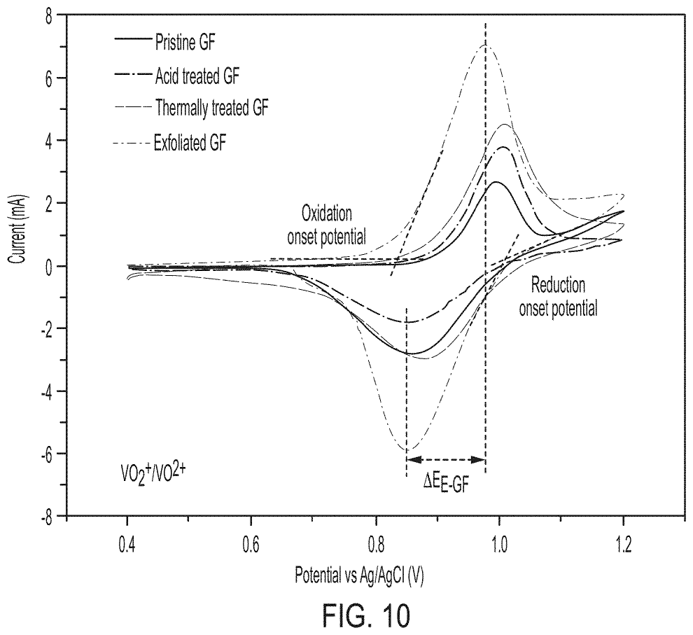

The superior electrochemical performance of E-GF electrode towards positive (VO₂⁺/VO²⁺) and negative (V³⁺/V²⁺) electrolytes is an indication of more rapid and reversible redox reactions with minimized overpotential and can be ascribed to the well organized hierarchical core-shell configuration containing massive surface oxygen groups. The incorporated oxygen groups behave as the active site for the redox reaction resulting in enhanced kinetics at the electrode-electrolyte interface, faster electron and ion transportation, and improved wettability enabling better electrolyte accessibility. To further investigate the reaction kinetics and evaluate the mass transfer behavior, the CV curves of the E-GF electrode were also acquired at different scan rates ranging from 1 to 10 mV s⁻¹ for VO⁺/VO²⁺ and V³⁺/V²⁺ redox couples, as displayed in FIGS. 3C and 3D, respectively. The CV curves of T-GF (FIG. 8A) and A-GF (FIG. 8B) electrodes were also obtained at various scan rates for VO⁺/VO²⁺ redox couple. In addition, the peak current densities of VO₂⁺/VO²⁺ (FIG. 3E) and V³⁺/V²⁺ (FIG. 3F) redox couples were plotted as a function of the square root of the scan rates, which exhibit linear shape implying a diffusion-controlled reaction. Moreover, the slopes of the E-GF electrode, corresponding to the reduction and oxidation of VO₂⁺/VO²⁺ and V³⁺/V²⁺ redox couples are the highest among the pristine GF and A-GF (FIG. 8C), indicating a distinct improvement in the mass transfer kinetics according to the Randles-Sevcik equation (see Experimental, Randles-Sevcik Equation). This substantial enhancement in diffusion is due to the superhydrophilic nature of the E-GF achieved by the introduction of the oxygen functional groups, which are extremely beneficial for the performance of the flow cell.

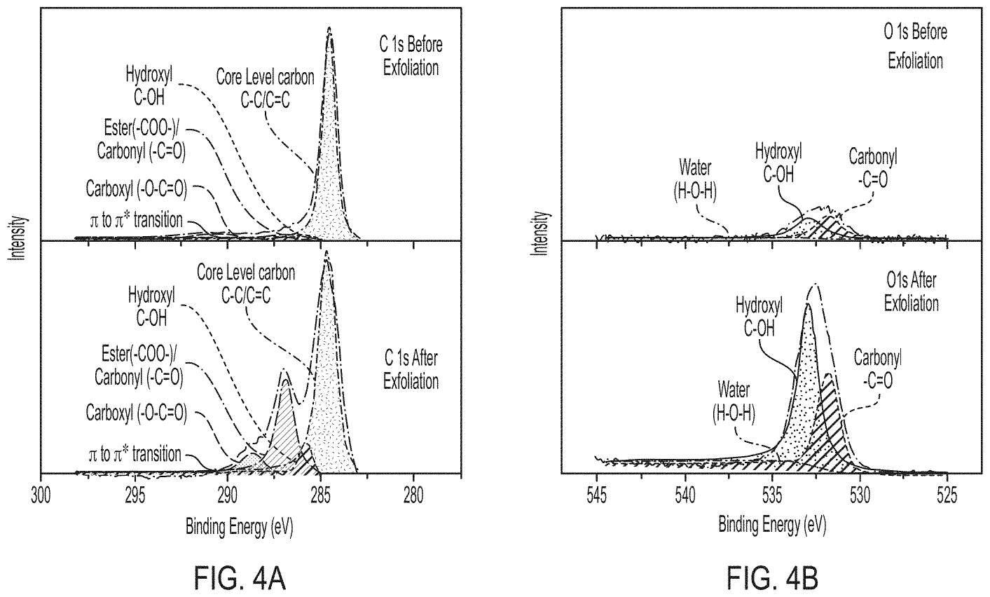

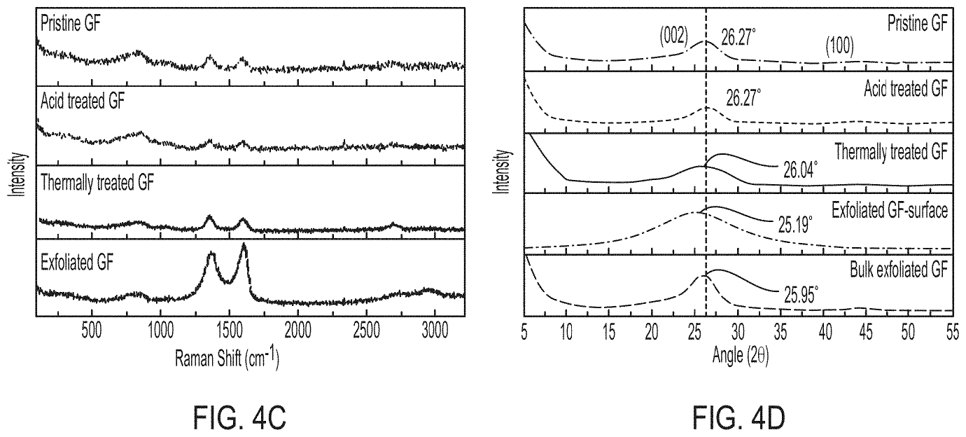

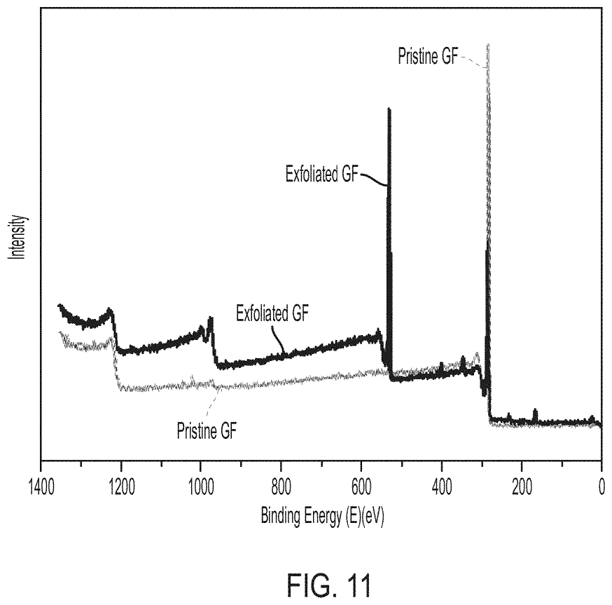

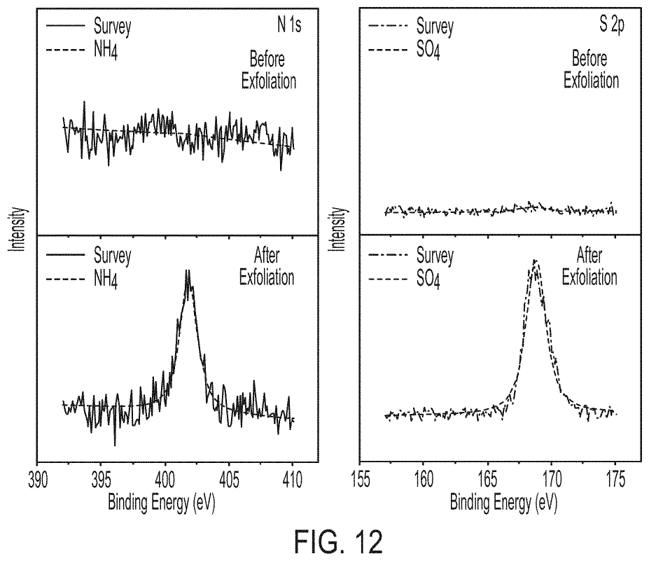

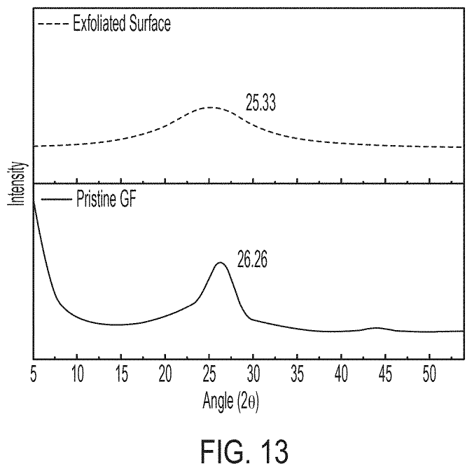

To get further insight into the elemental composition and presence of surface oxygen groups in E-GF electrode, X-ray photoelectron spectroscopy (XPS) was conducted. Only 3.66% atomic oxygen content was detected in the pristine GF sample arising from the spontaneous adsorption of oxygen on the carbon surface in air, while 25.48% atomic oxygen content was detected in the E-GF sample attributable to the oxidation of the E-GF sample due to the application of positive DC voltage during exfoliation. Thus, the oxygen to carbon ratio was increased from 0.039 (pristine GF) to 0.361, which confirms the grafting of different oxygen functional groups on E-GF. For further analysis, the high-resolution spectrum of C is region, presented in FIG. 4A, for pristine GF and E-GF electrodes were deconvoluted into four peaks at binding energies of 284.6, 285.8, 286.9, and 288.8 eV, each representing different carbon bonds. The peak at 284.6 eV is associated with the core level carbon atoms (C═C/C—C) in the graphitic carbon, whereas, the peaks at 285.8, 286.9, and 288.8 eV were assigned to the hydroxyl (—C—O—)³⁰ ester (—COO—)/carbonyl (—C═O)³¹, and carboxyl (—O—C═O)³² functional groups, respectively. Besides, another peak at 290.5 eV was also present in both of the electrodes attributable to the π to π* shake up satellite contributions.³³ Considerably, the intensities of all peaks related to the oxygen functional groups were increased in the E-GF electrode compared to the pristine GF electrode, implying the incorporation of oxygen groups in the E-GF electrode. Since the oxygen functional group is indeed related to the active site for the vanadium ions, the high-resolution O is spectra of pristine GF and E-GF were also fitted by deconvoluting three peaks at binding energies of 532.9, 533.1, and 531.8 eV, corresponding to the hydroxyl (—OH), water (H—O—H), and carbonyl (—C═O), respectively.^{32, 34} In E-GF electrode, the intensity of the —OH groups are higher compared to the —C═O, indicating that the exfoliation benefits the formation of —OH groups. These —OH group arises from the broken C═C bonds due to the strong oxidation and a part of the —OH groups further oxidizes and converts to —C═O.³⁵ It is worth mentioning that the —OH groups offer more electrochemically active sites compared to any other functional groups and thereby facilitates the redox reaction of vanadium.³⁶ Besides, the —OH and —C═O groups on the surface of E-GF electrode enhance its hydrophilicity that assist the electrolyte and ion diffusion through the E-GF electrode. Furthermore, wide range XPS scans obtained for E-GF electrode, as illustrated in FIG. 11, exhibit two new peaks for N 1s (401.8 eV) and S 2p (168.8 eV) compared to the pristine GF, which was also evident in the high resolution scans for N 1s and S 2p (FIG. 12). The presence of N 1s and S 2 p peaks are associated with the residual ammonia and sulfate ions due to the use of ((NH₄)₂)SO₄ electrolyte solution in the exfoliation process.

Moreover, as illustrated in FIG. 4C, Raman was also used to investigate the structural disorder of the GF before and after exfoliation. The Raman spectra for the GF samples exhibited two prominent bands one at 1355 cm⁻¹ (D band) corresponding to the breathing mode of the sp² carbon atoms activated by the presence of defects or structural disorder and another at 1591 cm⁻¹ (G band) associated with the well ordered sp² domains.^{6, 37} Intensity ratio of the D band and G band (I_{D}/I_{G}) indicates the existence of the defects. The pristine GF exhibited an I_{D}/I_{G} ratio of ˜1.13, which further increases for the A-GF (1.29) and T-GF (1.17) and diminished to ˜0.87 for the E-GF, verifying that the E-GF has lesser defect density compared to the pristine GF, A-GF, and T-GF. Hence, it is evident that the crystalline structure of the GF was not affected by 1 min exfoliation and thus, can maintain its high conductivity after 1 min exfoliation. The ability to maintain crystalline structure was also verified by the X-ray diffraction pattern (XRD) of the E-GF compared to the pristine GF, A-GF, and T-GF, as demonstrated in FIG. 4D. All the samples exhibit the most significant diffraction peak at around ˜26.3° with little deviation corresponding to the (002) plane indicating highly organized crystal structure with an interlayer spacing of ˜0.338 nm¹⁶ and one weak diffraction peaks around 44.3° associated with the (100) plane. It is worth mentioning that no visible changes in the layer distance between the pristine GF and the E-GF samples were observed since the expansion occurs only at the outer surface, but the solid core dominates the XRD results suppressing the small changes in peak positions originating from the layered shell due to the expanded graphite layers. However, the XRD spectra of the shell (the scraped off surface) of E-GF electrode exhibits the main peak at 25.19° verifying the expansion of graphite layers at the outer surface forming a well-organized core-shell structure, which accelerates the electron and ion transportation leading to better electrochemical performance.

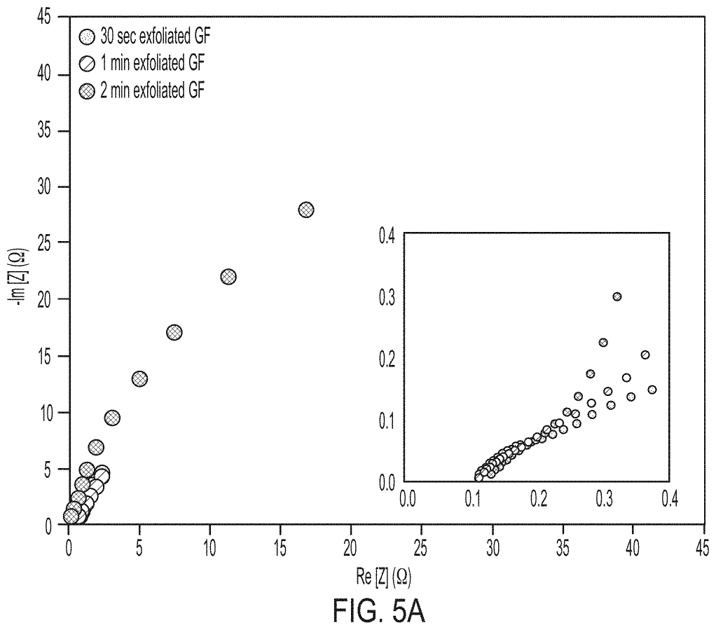

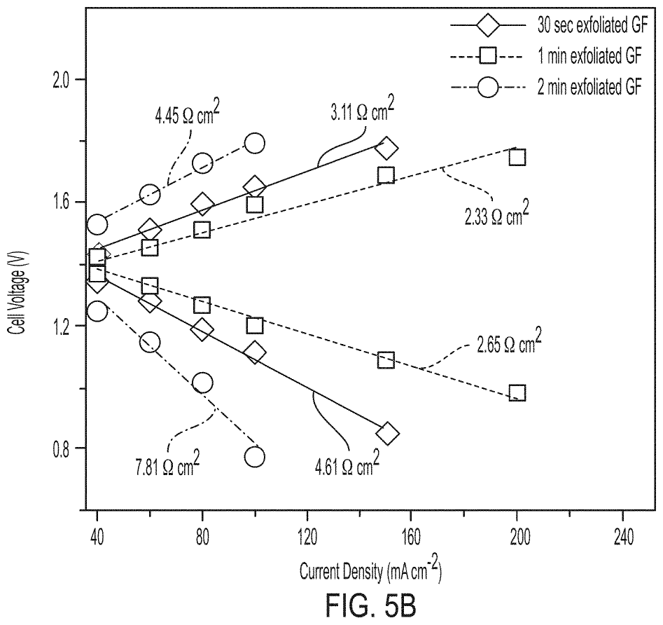

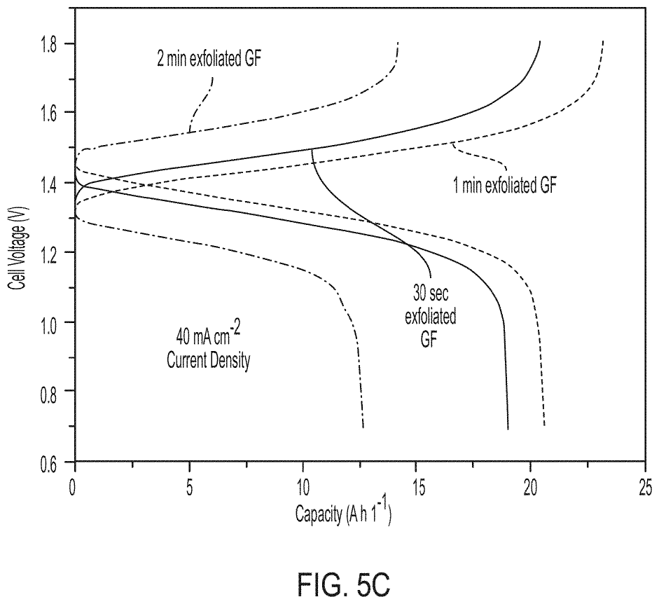

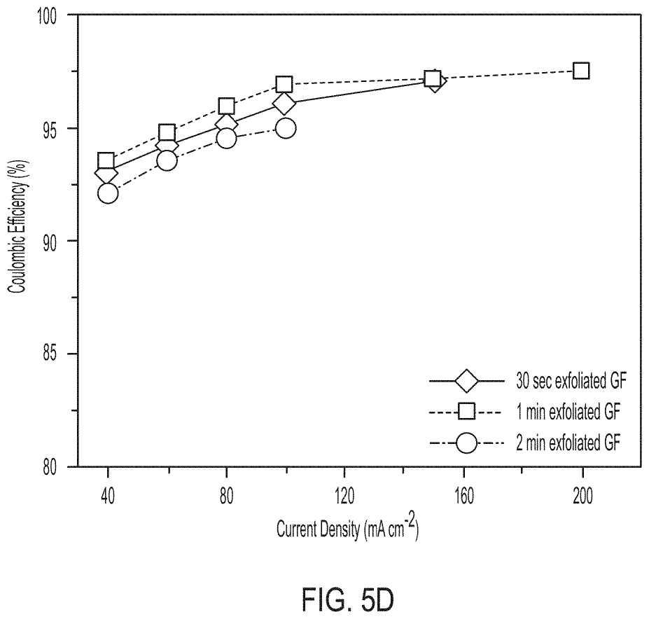

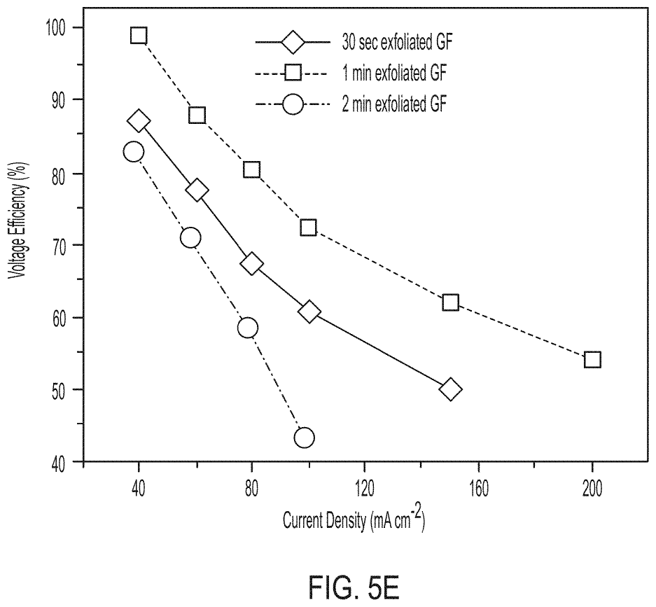

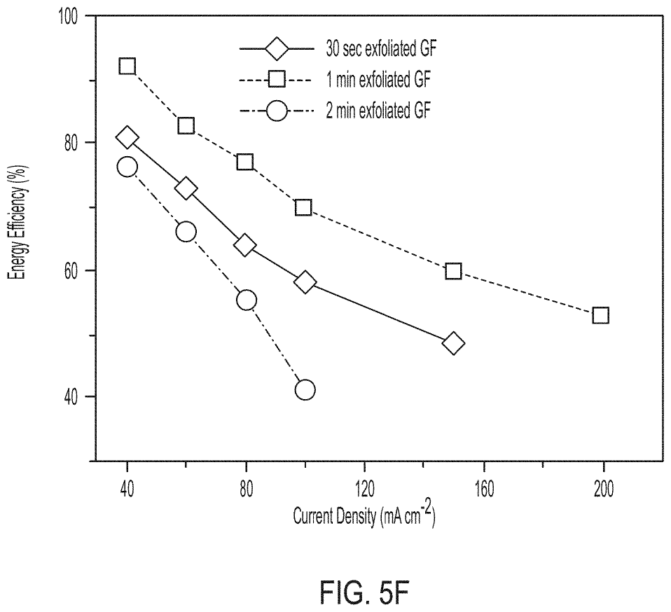

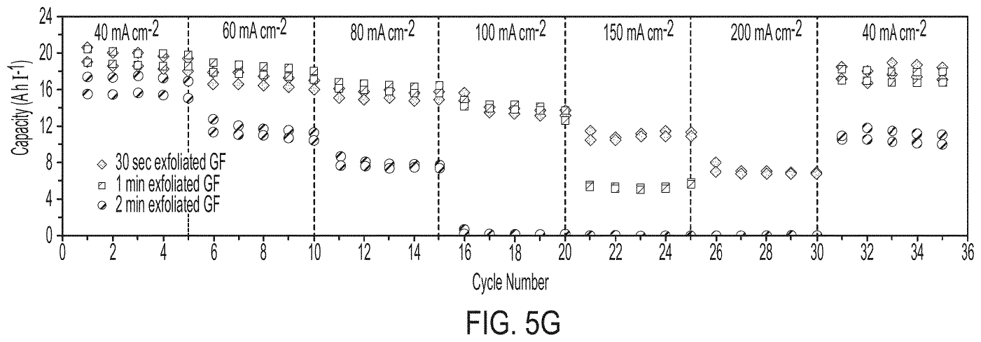

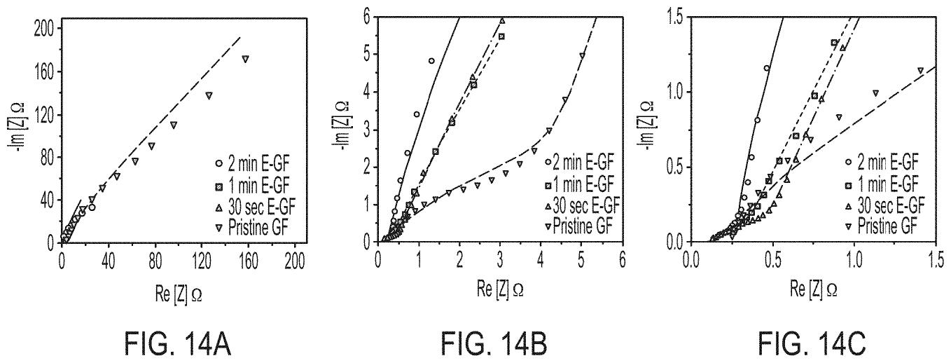

To further investigate the electrochemical activity of the E-GF electrodes with different exfoliation times, electrochemical impedance spectroscopy (EIS) was carried out at rest potential and the associated Nyquist plots are demonstrated in FIG. 5A. All the Nyquist plots exhibit a semicircle at the high frequency due to charge transfer process and a linear region at the low frequency due to the diffusion of the vanadium ions through the solution, indicating that the reaction is governed by both, the charge transfer and the diffusion.³⁸ From the fitted curves, as illustrated in FIGS. 14A-C, the 30 sec, 1 min, and 2 min exfoliated samples displayed ohmic resistance (Rₛ) of 0.111, 0.110, and 0.124Ω and charge transfer resistance (R_{ct}) of 0.438, 0.391, and 0.294Ω, respectively. Hence, it can be concluded that the variation in exfoliation time has a negligible effect on Rₛ, which is the ohmic resistance of the cell. However, the R_{ct} exhibits a declining trend with increasing exfoliation time, indicating an acceleration of the charge transfer between the vanadium ions and the electrodes attributable to the increase in the concentration of surface oxygen groups owing to the overoxidation of the E-GF electrodes for longer exfoliation times.

On the other hand, the area specific resistance (ASR) that combines the charge transfer, ohmic, and mass transport resistance of the flow cell seems to be lowest for 1 min E-GF electrode compared to the 30 sec and 2 min E-GF electrodes, as shown in FIG. 5B. The ASR during charge are 3.11, 2.33, and 4.45 and during discharge are 4.61, 2.65, 7.81 Ωcm² for 30 sec, 1 min, and 2 mins E-GF, correspondingly, which undoubtedly endorse the superiority of the 1 min E-GF electrode among the others. In addition, the voltage profiles of 1 min E-GF electrode has 3 and 14 mV lower overpotential (FIG. 5C) at the same current density of 40 mA cm⁻² compared to the 30 sec and 2 min E-GF electrodes during the charge and discharge of the flow cell, respectively, indicating higher electrochemical activity of the 1 min E-GF electrode. The performance of the 30 sec, 1 min, and 2 min E-GF was also analyzed based on the coulombic efficiency (CE), voltage efficiency (VE), and energy efficiency (EE) at the current density ranging from 40 to 200 mA cm⁻², as demonstrated in FIGS. 5D-F. The CE of all the E-GF electrodes exhibited similar values at same current densities, whereas, the VE and EE of the 1 min E-GF electrode were much higher than the 30 sec and 2 min E-GF electrodes at all the current density.

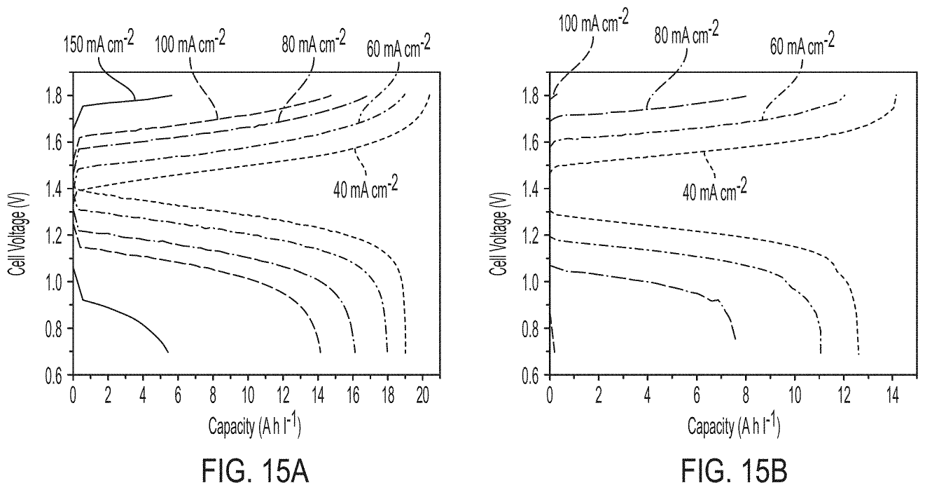

The enhancement in the electrochemical properties of the 1 min E-GF electrode is more predominant at a higher current density of 200 mA cm⁻², where the 1 min E-GF electrode achieves a high capacity but the 30 sec and 2 min E-GF electrodes can not complete charge-discharge cycles within the same operating voltage window. The 1 min E-GF electrode acquired capacities of 20.6, 16.4, 14.9, 13.5, 10.7, and 6.8 A h l⁻¹ at the current densities of 40, 60, 80, 100, 150, and 200 mA cm⁻², whereas the 30 sec and 2 min E-GF electrodes can run maximum current densities of 150 and 100 mA cm⁻², respectively (FIG. 5G). In addition, the 30 sec, 1 min, and 2 min E-GF electrodes regain ˜90, 94, and 68% of their original capacity when returned to the initial current density of 40 mA cm⁻², which further confirms the superior rate performance of 1 min E-GF electrode due to the higher electrical conductivity of the 1 min E-GF electrode among the others FIG. 15A-B; Table 2). Thus, the 1 min E-GF electrode preserves an optimum balance between conductivity and wettability since conductivity decreases with increasing exfoliation time (Table 2) that negatively influences the charge transfer resistance of the electrode. Simultaneously, the E-GF electrode becomes more hydrophilic as the exfoliation time increases, facilitating better electrolyte accessibility. Accordingly, the 1 min was chosen as the optimal exfoliation time and is used for further experiments.

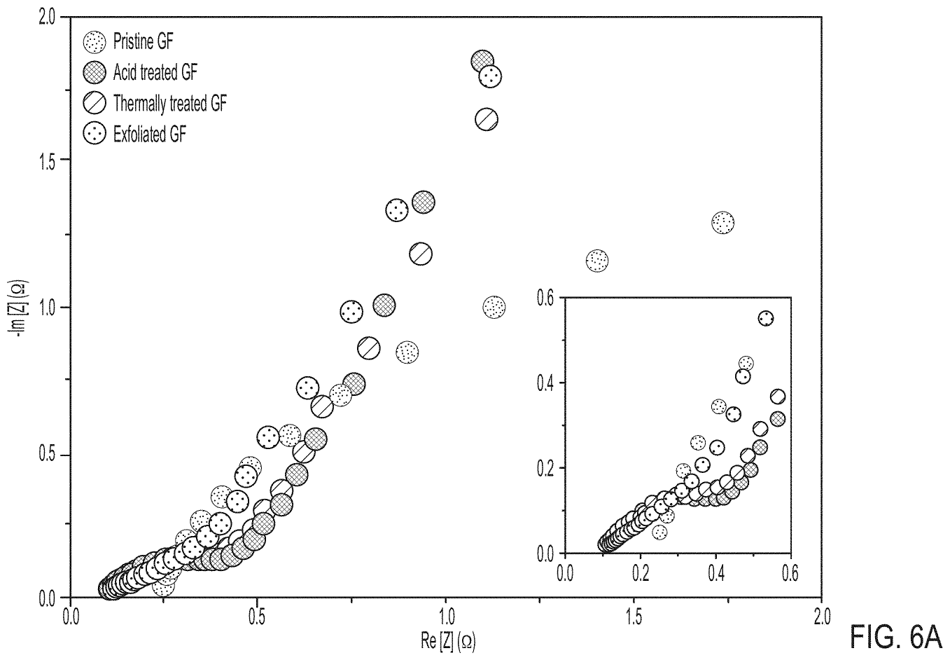

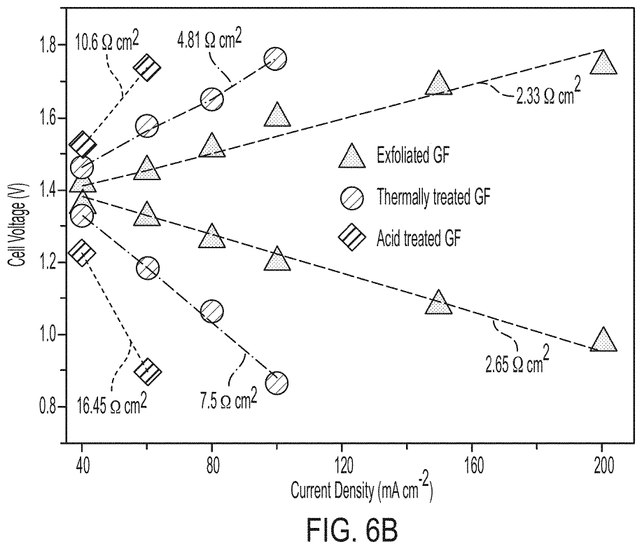

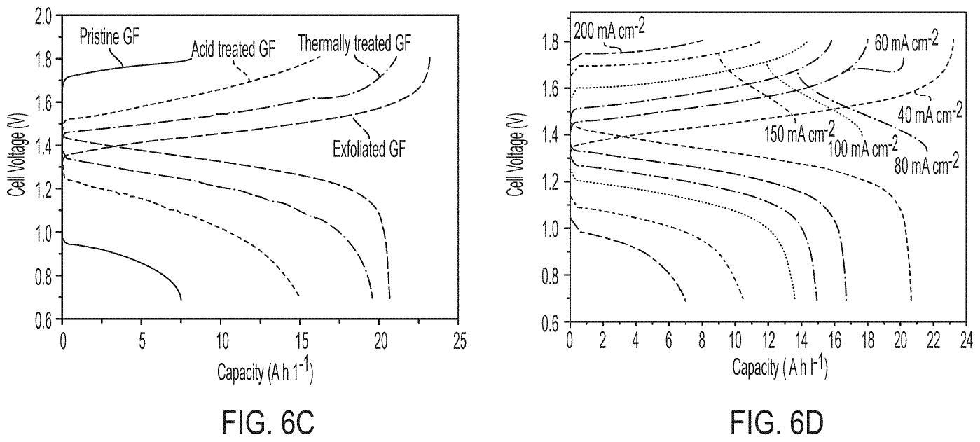

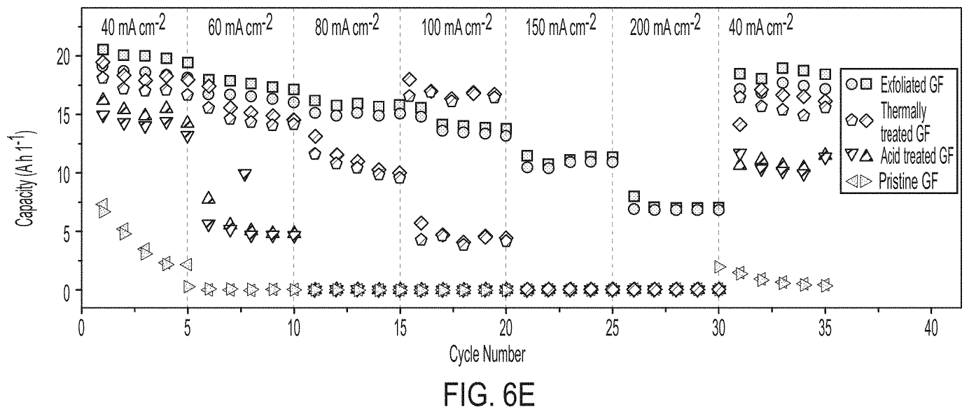

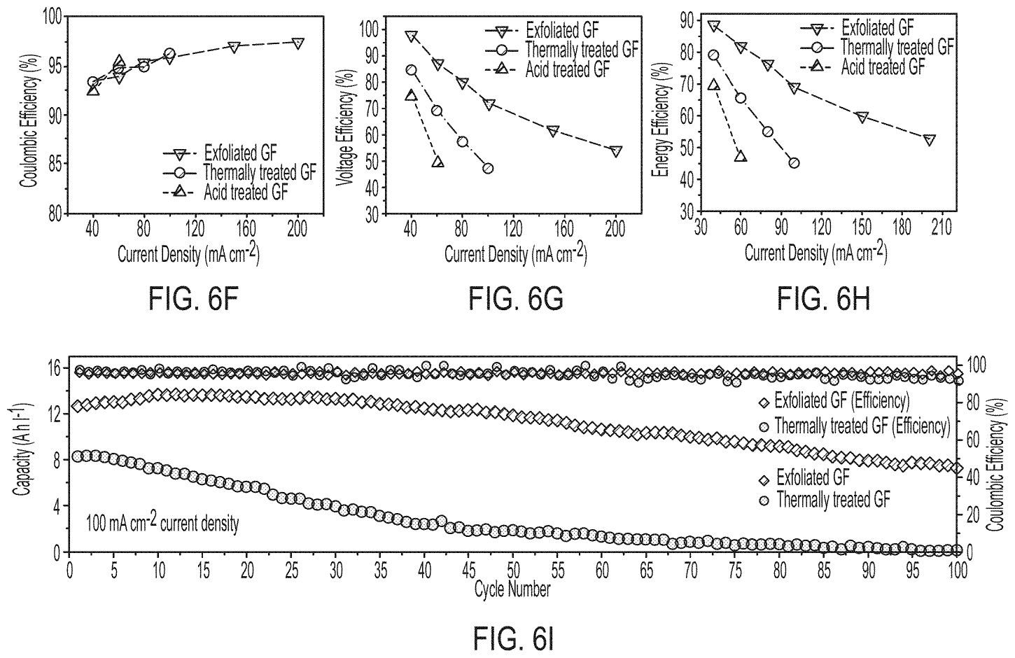

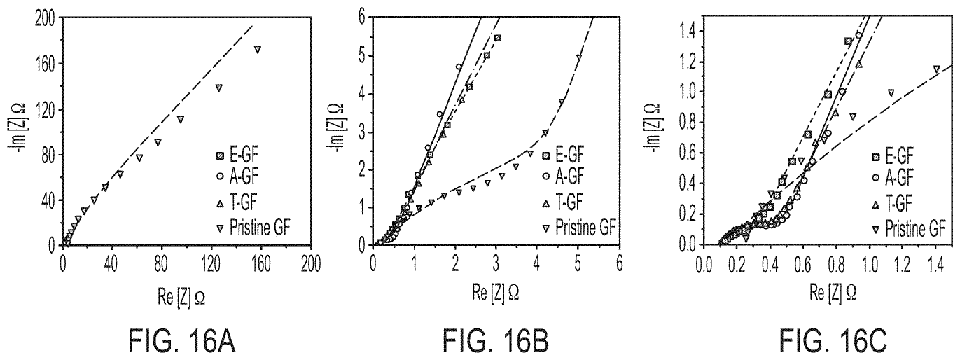

To further confirm the electrochemical performance, EIS for all the control samples with different type of treatments were conducted in the flow cell (FIG. 6A and FIGS. 16A-C), where the pristine GF, A-GF, T-GF, and E-GF electrodes exhibit Rₛ of 0.128, 0.103, 0.105, and 0.101Ω; and R_{ct} of 10.36, 4.09, 0.39, and 0.36Ω. The R_{ct} gradually decreases in the order of pristine GF, A-GF, T-GF, and E-GF, indicating excellent charge transfer capability of the E-GF electrodes due to the improved hydrophilicity. Furthermore, ASR obtained for the A-GF, T-GF, and E-GF electrodes are 10.60, 4.81, and 2.33 Ωcm² during charge and 16.45, 7.50, 2.65 Ωcm² during discharge (FIG. 6B), suggesting the lowest ASR for the E-GF electrode among the others. FIG. 6C exhibits the charge-discharge voltage profiles at the same current density, where a noticeably reduced overpotential of 370 and 490 mV compared to pristine GF, 170 and 190 mV compared to A-GF, and 110 and 100 mV compared to T-GF was achieved during charge and discharge, respectively. The E-GF electrode attains a capacity of 20.6 A h l⁻¹, while the T-GF, A-GF, and pristine GF electrodes obtain 19.5, 14.9, and 7.4 A h l⁻¹ respectively, at the same current density (40 mA cm⁻²) and operating voltage window. The obtained results suggest the effect of exfoliation of the GF electrode leads to smaller overpotential enabling a significantly higher capacity than the pristine GF, which can be ascribed to the abundant active reaction sites facilitating fast oxygen and electron transfer and enhanced wettability allowing the rapid mass transfer. It is worth mentioning that the E-GF electrode exhibited a predominant mass transfer limited region towards the end of the charge/discharge curves, which, without wishing to be bound by theory, is related to the “electrode starvation” as mentioned by Zawodzinski et al.³⁹ “Electrode starvation” arises when all the electroactive species completely converts at the operating current density causing mass transport limited region in the charge discharge curves. Therefore, the presence of “electrode starvation” along with the higher capacities for the E-GF electrode further indicate better utilization of the electrolyte compared to the other samples at the same current density.

Likewise, the smaller overpotential is also well defined in the charge-discharge profiles of the E-GF electrodes at different current densities (FIG. 6D), where the voltage gap rises with the increase in the current density leading to a reduction in achieved capacity with the increasing current density due to the increased ohmic loss and mass transport limitations at higher current densities. As depicted in FIG. 6E, the E-GF electrode regains ˜94% of its initial capacity when returned to the initial current density that evidence much-enhanced rate performance of E-GF electrode even at higher current densities compared to the pristine GF, A-GF, and T-GF. The drastic improvement in the rate performance can be attributed to the rapid electron transportation and super hydrophilic nature of the E-GF electrode owing to the functional oxygen groups.

Notably, except the E-GF, all other electrodes illustrated substantially high overpotential for the charge and discharge at the high current density and cannot successfully run within the operating voltage window. Consequently, the efficiencies for pristine GF was excluded from FIGS. 6F-H, for A-GF and T-GF were obtained by varying the current density from 40-60 and 40-100 mA cm⁻², and for E-GF the current density was varied from 40-200 mA cm⁻². As anticipated, different modifications have a negligible effect on the CE at the same charge-discharge rate, and the CE increases with the increase in the current density owing to the lower self-discharge across the membrane in the shorter cycle time with the increasing current density.⁴⁰ However, the modifications significantly impact the VE of the cell, which are 98.53, 87.64, 80.38, 72.13, 61.86, and 54.23% for E-GF at current densities of 40, 60, 80, 100, 150, and 200 mA cm⁻²; 85.01, 69.36, 57.90, and 47.13% for T-GF at current densities of 40, 60, 80, and 100 mA cm⁻²; and 75.23 and 47.14% for A-GF at current densities of 40 and 60 mA cm⁻², respectively. The achieved VE for E-GF at all current densities are clear indications of the improved electrocatalytic effect and rapid charge transfer of the E-GF electrode accredited to the introduction of sufficient surface oxygen groups without sacrificing the high electrical conductivity and extreme hydrophilicity prompting instantaneous absorption of the electrolytes onto the E-GF surface.

Further, to verify the electrochemical reversibility and stability, a constant current charge-discharge cycling of the E-GF and T-GF electrode was conducted at a current density of 100 mA cm⁻², as demonstrated in FIG. 6I, where the E-GF electrode displays a stable CE of ˜96% throughout the cycles. Although, both the electrodes showed a gradual capacity fade due to the vanadium crossover across the Nafion membrane,⁴¹ the capacity retention of the E-GF electrode is much higher compared to the T-GF electrode showing the enhanced stability of the E-GF compared to the T-GF.

Thus, the obtained results validate the superior electrocatalytic activity and stability of the E-GF electrode compared to the pristine GF, A-GF, and T-GF electrode in the VRFB. Without wishing to be bound by theory, the surface oxygen groups catalyze the VO²⁺/VO₂⁺ reaction due to the two main reasons: (1) the C—O groups intensify the adsorption of the VO²⁺ ions by supplying protons that facilitate the transport of VO²⁺ ions from the solution to the electrode surface; and (2) the charge and discharge process at the positive side requires the transfer of an oxygen atom along with the electron transfer and the existence of the C—OH and O—C═O groups on the GF surface assists in the oxygen transfer⁴², which is a rate-determining step in the VRFB.

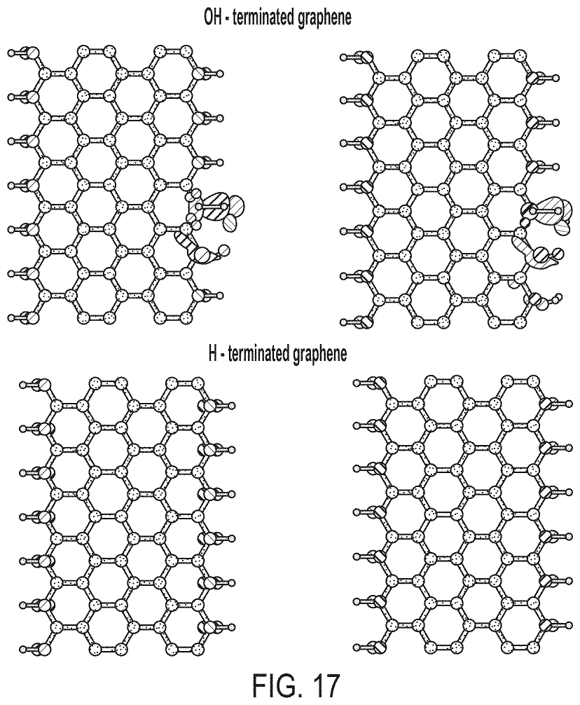

To better the understand the role of increased oxygen content in promoting the vanadium redox couple reaction in E-GF electrode, spin-polarized density functional theory calculations were carried out using Vienna Ab initio Simulation Package (VASP). In the simulation, the E-GF electrode was designated as -OH-terminated graphene since the exfoliation introduces hydroxyl groups (—OH) at the edge sites that contribute to most of the oxygen content in the obtained E-GF electrode, which is also in well accordance with the XPS results (FIGS. 4A-B). Whereas, the pristine GF with low oxygen content was simulated as H-terminated graphene. The charge density differences between the two kinds of graphene are evident in FIG. 17. The additional surface oxygen groups in —OH-terminated graphene created localized states around the —OH dopant when there was an extra +1/−1 charge, which was transferred from VO₂⁺/VO²⁺ and V²⁺/V³⁺ to E-GF electrodes, suggesting an increase in charge concentration in the system for the E-GF electrode compared to the pristine GF electrode. Therefore, it is apparent that the increased oxygen content in the E-GF electrode facilitates electron transport in VO⁺/VO²⁺ and V²⁺/V³⁺ redox couple reaction by increasing the local charge concentration in the system, which further enhances the electrochemical performance of the E-GF electrode.

TABLE 1
Summary of important cyclic voltammetry parameters for exfoliated
graphite felts for different times ranging from 1 min to 4 min.

| | Different Exfoliation Times | | | | |
|---|---|---|---|---|---|
| Important Parameters | 30 sec | 1 min | 2 min | 3 min | 4 min |

For VO₂⁺/VO²⁺ redox couple

| | | | | | |
|---|---|---|---|---|---|
| Peak separation (V) | 0.4289 | 0.42529 | 0.419 | 0.4045 | 0.3745 |
| Oxidation onset potential (V) | 0.94 | 0.926 | 0.884 | 0.898 | 0.8758 |
| Reduction onset potential (V) | 0.9733 | 0.992 | 0.986 | 0.991 | 0.9927 |
| Oxidation Peak Current (mA) | 62.7 | 63.8 | 59.1 | 55.8 | 54.4 |
| Reduction Peak Current (mA) | 29.15 | 29.97 | 30.04 | 30.14 | 29.94 |

For V³⁺/V²⁺ redox couple

| | | | | | |
|---|---|---|---|---|---|
| Peak separation (V) | 0.3775 | 0.38586 | 0.3997 | 0.366 | 0.36874 |
| Oxidation onset potential (V) | −0.573 | −0.5377 | −0.5389 | −0.54 | −0.5089 |
| Reduction onset potential (V) | −0.4545 | −0.429 | −0.422 | −0.4294 | −0.4163 |
| Oxidation Peak Current | 31.19 | 29.70 | 30.73 | 30.18 | 28.83 |
| Reduction Peak Current | 61.75 | 55.14 | 54.78 | 53.32 | 52.68 |

TABLE 2
Sheet Resistance Measurement

| | Sheet resistance (Ω/□) |
|---|---|
| Pristine GF | 0.575 |
| 30 sec exfoliated GF | 0.9 |
| 1 min exfoliated GF | 2.1 |
| 2 min exfoliated GF | 3.79 |
| Acid treated GF | 0.66 |
| Thermally treated GF | 2.5 |

### Conclusion

In summary, the striking effect of the hierarchical core-shell fiber framework enriched with functional oxygen groups on E-GF electrode in promoting the redox reaction of RFB was investigated. Core-shell fiber framework with increased hydrophilicity, enhanced charge transfer, and abundant reaction sites for the redox couple was created by electrochemical exfoliation of GF in aqueous ((NH₄)₂SO₄ solution. The as-prepared E-GF electrode exhibits a substantial enhancement in electrochemical performance in the VRFB confirming the beneficial role of functional oxygen groups incorporated in the GF electrode. Consequently, the E-GF electrode obtains a volumetric capacity of ˜20.6 A h l⁻¹, which is ˜2.8 times higher than the pristine GF. Further, E-GF electrode regains ˜94% of its initial capacity when returned to the initial current density of 40 mA cm⁻², suggesting an excellent rate performance. In addition, E-GF electrode achieves a VE of ˜73%, EE of ˜70% at 100 mA cm⁻², and long term cycling of 100 cycles with an average capacity fade of 0.42% per cycle, which verifies superior stability of the E-GF electrode in VRFB. Furthermore, an in-depth study using spin-polarized density functional theory evidences a faster electron transport and reduced discharge overpotential in the as-prepared E-GF electrode. In addition to offering significant improvements in the performance of VRFB, the approach of room temperature, 1 min electrochemical exfoliation in low cost and friendly aqueous solution to modify GF electrodes holds great promise for large scale industrial application as the process is rapid, scalable, and energy efficient. Finally, it can open a new avenue of an effective and promising graphite electrode surface modification for various applications.

### Materials and Methods

Synthesis of Electrodes

AvCarb G100 Soft Graphite Battery Felt (AvCarb Material Solutions, Lowell, Mass. 01851, USA) was used for the entire work. The electrochemical exfoliation was conducted in a two-electrode setup, where the pristine GF was used as both cathode and anode, and a 0.1 M ((NH)₄)₂SO₄ aqueous solution was used as the electrolyte. The distance between the two electrodes was kept constant at ˜2 cm throughout the electrochemical process. A positive bias voltage of 10 V was applied for various times starting from 30 sec to 4 min and the felts were washed several times with deionized water to get rid of any residual electrolyte. To prepare the T-GF electrodes, the pristine GF were thermally treated in a tube furnace in an air atmosphere at 400° C. for 10 hours. The A-GF electrodes were obtained by treating the pristine GF with a concentrated 3:1 mixture of sulfuric acid and nitric acid at 60° C. for 6 hours. All the samples were thoroughly washed and sonicated in deionized water for 5 mins before use.

Characterization

Cyclic voltammetry (CV) experiments were performed using a Biologic SP150 potentiostat controlled by Biologic EC-Lab software. A graphite rod and Ag/AgCl were used as the counter and reference electrodes, respectively. The working electrodes were prepared by attaching a piece of felt at the tip of a graphite rod and a 0.1 M vanadyl sulfate (VOSO₄) was used as the electrolytes for all the CV experiments. Note that the 2^{nd} cycle of the CV was used for all the samples. In addition, the morphology of the pristine GF and E-GF was characterized by an FE-SEM (SUPRA 25) using an accelerating voltage of 5 K eV. The structure of the samples was characterized by Raman spectra (Lab Ram HR800 UV NIR with 532 nm laser excitation) and X-ray diffraction (PANalytical/Philips X'Pert Pro scattering system with Ni-filtered Cu Kα radiation. The surface composition of the GF samples was analyzed using X-ray photoelectron spectroscopy (XPS, Thermo Scientific K-Alpha).

Flow Cell Test

The setup of the flow cell is described in detail in a prior publication.⁴² The active area of the electrodes at both sides are 5 cm², and the cell was assembled using a Nafion 115 membrane (Chemours). The membranes were pretreated by boiling at 85° C. in deionized water for 15 mins followed by soaking in 5% H₂O₂ solution for 30 mins. Afterwards, the membranes were rinsed thoroughly with deionized water and soaked in 0.1 M H₂SO₄ solution for 30 mins and washed with deionized water before use. The cell also contains two electrolyte reservoirs of 50 mL. The electrolytes were pumped at a flow rate of 20 mL min⁻¹ using a peristaltic pump and the flow rate was kept constant for all the experiments. The positive and negative side was sparged with nitrogen gas before running and sealed properly to prevent oxygen exposure. Initially, the electrolytes were prepared by dissolving 1 M VOSO₄ (Aldrich, 99%) in 3 M H₂SO₄ (Aldrich, 97%) solution. To prepare the positive and negative side electrolytes, the cell was charged at a constant voltage of 1.75 V until the current drops below 5 mA, which is an indication of complete conversion to V(V) and V(II) on the positive and negative sides, respectively.

Electrochemical Impedance Spectroscopy (EIS) was performed at rest potential by applying a sine voltage waveform of amplitude 10 mV added to an offset voltage. The frequency of the sine voltage was varied stepwise from 100 KHz to 100 mHz, with 6 points per decade in logarithmic spacing. The electrochemical charge-discharge of the flow cell was conducted using a potentiostat (LAND) under a constant current density ranging from 40-200 mA cm⁻².

Computational Details

Spin-polarized density functional theory calculations were performed using Vienna Ab-initio Simulation Package (VASP)⁴³⁻⁴⁴ with projector augmented wave (PAW) pseudopotential⁴⁵⁻⁴⁶ and Perdew-Burke-Ernzerhof (PBE) exchange-correlation functional.⁴⁷⁻⁴⁸ A kinetic energy cut-off of 400 eV was adopted for the plane-wave expansion, and all atomic positions were fully relaxed until the final force on each atom was less than 0.05 eV/Å.

Randles-Sevcik Equation

Randles-Sevcik equation describes the effect of scan rate on the peak current Iₚ and can be represented as follows:

$${I}_{p} = 0.4463 n F A {C ( \frac{nf ϑ d}{R T} )}^{\frac{1}{2}} \qquad ( Equation 1 )$$

Where,

Iₚ=Peak current in amps

n=Number of electrons transferred in the redox event (1 for VO₂⁺/VO²⁺ and V³⁺/V²⁺ redox couples)

A=Electrode area in cm²

F=Faraday Constant in C mol⁻¹

D=Diffusion coefficient in cm² s−1

C=Concentration in mol cm⁻³

ν=Scan rate in V/s

R=Gas constant in J K⁻¹ mol⁻¹

T=Temperature in K

### REFERENCES

1. Liu, Y.; Shen, Y.; Yu, L.; Liu, L.; Liang, F.; Qiu, X.; Xi, J., Holey-engineered electrodes for advanced vanadium flow batteries. Nano Energy 2018, 43, 55-62.

2. Li, B.; Gu, M.; Nie, Z.; Shao, Y.; Luo, Q.; Wei, X.; Li, X.; Xiao, J.; Wang, C.; Sprenkle, V., Bismuth nanoparticle decorating graphite felt as a high-performance electrode for an all-vanadium redox flow battery. Nano letters 2013, 13 (3), 1330-1335.

3. Deng, Q.; Huang, P.; Zhou, W. X.; Ma, Q.; Zhou, N.; Xie, H.; Ling, W.; Zhou, C. J.; Yin, Y. X.; Wu, X. W., A High-Performance Composite Electrode for Vanadium Redox Flow Batteries. Advanced Energy Materials 2017, 7 (18), 1700461.

4. Kim, K. J.; Park, M.-S.; Kim, Y.-J.; Kim, J. H.; Dou, S. X.; Skyllas-Kazacos, M., A technology review of electrodes and reaction mechanisms in vanadium redox flow batteries. Journal of Materials Chemistry A 2015, 3 (33), 16913-16933.

5. Sun, B.; Skyllas-Kazakos, M., Chemical modification and electrochemical behaviour of graphite fibre in acidic vanadium solution. Electrochimica Acta 1991, 36 (3-4), 513-517.

6. Aziz, M. A.; Shanmugam, S., Zirconium oxide nanotube—Nafion composite as high performance membrane for all vanadium redox flow battery. Journal of Power Sources 2017, 337, 36-44.

7. Di Blasi, A.; Busaccaa, C.; Di Blasia, O.; Briguglioa, N.; Squadritoa, G.; Antonuccia, V., Synthesis of flexible electrodes based on electrospun carbon nanofibers with Mn3O4 nanoparticles for vanadium redox flow battery application. Applied Energy 2017, 190, 165-171.

8. Hosseini, M. G.; Mousavihashemi, S.; Murcia-López, S.; Flox, C.; Andreu, T.; Morante, J. R., High-power positive electrode based on synergistic effect of N-and WO3-decorated carbon felt for vanadium redox flow batteries. Carbon 2018, 136, 444-453.

9. Vázquez-Galván, J.; Flox, C.; Fàbrega, C.; Ventosa, E.; Parra, A.; Andreu, T.; Morante, J. R., Hydrogen-Treated Rutile TiO2 Shell in Graphite-Core Structure as a Negative Electrode for High-Performance Vanadium Redox Flow Batteries. ChemSusChem 2017, 10 (9), 2089-2098.

10. Jing, M.; Zhang, X.; Fan, X.; Zhao, L.; Liu, J.; Yan, C., CeO2 embedded electrospun carbon nanofibers as the advanced electrode with high effective surface area for vanadium flow battery. Electrochimica Acta 2016, 215, 57-65.

11. Wu, X.; Xu, H.; Lu, L.; Zhao, H.; Fu, J.; Shen, Y.; Xu, P.; Dong, Y., PbO2-modified graphite felt as the positive electrode for an all-vanadium redox flow battery. Journal of Power Sources 2014, 250, 274-278.

12. Bayeh, A. W.; Kabtamu, D. M.; Chang, Y.-C.; Chen, G.-C.; Chen, H.-Y.; Lin, G.-Y.; Liu, T.-R.; Wondimu, T. H.; Wang, K.-C.; Wang, C.-H., Ta2O5-Nanoparticle-Modified Graphite Felt As a High-Performance Electrode for a Vanadium Redox Flow Battery. ACS Sustainable Chemistry & Engineering 2018, 6 (3), 3019-3028.

13. Fetyan, A.; El-Nagar, G. A.; Derr, I.; Kubella, P.; Dau, H.; Roth, C., A neodymium oxide nanoparticle-doped carbon felt as promising electrode for vanadium redox flow batteries. Electrochimica Acta 2018, 268, 59-65.

14. Li, B.; Gu, M.; Nie, Z.; Wei, X.; Wang, C.; Sprenkle, V.; Wang, W., Nanorod niobium oxide as powerful catalysts for an all vanadium redox flow battery. Nano letters 2013, 14 (1), 158-165.

15. González, Z.; Flox, C.; Blanco, C.; Granda, M.; Morante, J. R.; Menéndez, R.; Santamaria, R., Outstanding electrochemical performance of a graphene-modified graphite felt for vanadium redox flow battery application. Journal of Power Sources 2017, 338, 155-162.

16. Han, P.; Wang, H.; Liu, Z.; Chen, X.; Ma, W.; Yao, J.; Zhu, Y.; Cui, G., Graphene oxide nanoplatelets as excellent electrochemical active materials for VO2+/VO2+ and V2+/V3+ redox couples for a vanadium redox flow battery. Carbon 2011, 49 (2), 693-700.

17. Li, W.; Liu, J.; Yan, C., The electrochemical catalytic activity of single-walled carbon nanotubes towards VO2+/VO2+ and V3+/V2+ redox pairs for an all vanadium redox flow battery. Electrochimica Acta 2012, 79, 102-108.

18. Li, W.; Liu, J.; Yan, C., Multi-walled carbon nanotubes used as an electrode reaction catalyst for VO2+/VO2+ for a vanadium redox flow battery. Carbon 2011, 49 (11), 3463-3470.

19. Wang, S.; Zhao, X.; Cochell, T.; Manthiram, A., Nitrogen-doped carbon nanotube/graphite felts as advanced electrode materials for vanadium redox flow batteries. The journal of physical chemistry letters 2012, 3 (16), 2164-2167.

20. Huang, P.; Ling, W.; Sheng, H.; Zhou, Y.; Wu, X.; Zeng, X.-X.; Wu, X.; Guo, Y.-G., Heteroatom-doped electrodes for all-vanadium redox flow batteries with ultralong lifespan. Journal of Materials Chemistry A 2018, 6 (1), 41-44.

21. Jiang, H. R.; Shyy, W.; Zeng, L.; Zhang, R. H.; Zhao, T. S., Highly efficient and ultra-stable boron-doped graphite felt electrodes for vanadium redox flow batteries. Journal of Materials Chemistry A 2018, 6 (27), 13244-13253.

22. Sun, B.; Skyllas-Kazacos, M., Modification of graphite electrode materials for vanadium redox flow battery application—I. Thermal treatment. Electrochimica Acta 1992, 37 (7), 1253-1260.

23. Zhang, Z.; Xi, J.; Zhou, H.; Qiu, X., KOH etched graphite felt with improved wettability and activity for vanadium flow batteries. Electrochimica Acta 2016, 218, 15-23.

24. Park, J. J.; Park, J. H.; Park, O. O.; Yang, J. H., Highly porous graphenated graphite felt electrodes with catalytic defects for high-performance vanadium redox flow batteries produced via NiO/Ni redox reactions. Carbon 2016, 110, 17-26.

25. Parvez, K.; Li, R.; Puniredd, S. R.; Hernandez, Y.; Hinkel, F.; Wang, S.; Feng, X.; Müllen, K., Electrochemically exfoliated graphene as solution-processable, highly conductive electrodes for organic electronics. ACS nano 2013, 7 (4), 3598-3606.

26. Lu, J.; Yang, J.-x.; Wang, J.; Lim, A.; Wang, S.; Loh, K. P., One-pot synthesis of fluorescent carbon nanoribbons, nanoparticles, and graphene by the exfoliation of graphite in ionic liquids. ACS nano 2009, 3 (8), 2367-2375.

27. Parvez, K.; Wu, Z.-S.; Li, R.; Liu, X.; Graf, R.; Feng, X.; Müllen, K., Exfoliation of graphite into graphene in aqueous solutions of inorganic salts. Journal of the American Chemical Society 2014, 136 (16), 6083-6091.

28. Wu, L.; Shen, Y.; Yu, L.; Xi, J.; Qiu, X., Boosting vanadium flow battery performance by Nitrogen-doped carbon nanospheres electrocatalyst. Nano Energy 2016, 28, 19-28.

29. Sonkar, P. K.; Prakash, K.; Yadav, M.; Ganesan, V.; Sankar, M.; Gupta, R.; Yadav, D. K., Co (II)-porphyrin-decorated carbon nanotubes as catalysts for oxygen reduction reactions: an approach for fuel cell improvement. Journal of Materials Chemistry A 2017, 5 (13), 6263-6276.

30. Sadri, R.; Hosseini, M.; Kazi, S.; Bagheri, S.; Zubir, N.; Solangi, K.; Zaharinie, T.; Badarudin, A., A bio-based, facile approach for the preparation of covalently functionalized carbon nanotubes aqueous suspensions and their potential as heat transfer fluids. Journal of colloid and interface science 2017, 504, 115-123.

31. Wu, G.; Xu, B.-Q., Carbon nanotube supported Pt electrodes for methanol oxidation: A comparison between multi-and single-walled carbon nanotubes. Journal of Power Sources 2007, 174 (1), 148-158.

32. Kabtamu, D. M.; Chen, J.-Y.; Chang, Y.-C.; Wang, C.-H., Water-activated graphite felt as a high-performance electrode for vanadium redox flow batteries. Journal of Power Sources 2017, 341, 270-279.

33. Cao, L.; Skyllas-Kazacos, M.; Wang, D.-W., Effects of surface pretreatment of glassy carbon on the electrochemical behavior of V (IV)/V (V) redox reaction. Journal of The Electrochemical Society 2016, 163 (7), A1164-A1174.

34. Liu, T.; Li, X.; Nie, H.; Xu, C.; Zhang, H., Investigation on the effect of catalyst on the electrochemical performance of carbon felt and graphite felt for vanadium flow batteries. Journal of Power Sources 2015, 286, 73-81.

35. Zhang, L.; Shao, Z.-G.; Wang, X.; Yu, H.; Liu, S.; Yi, B., The characterization of graphite felt electrode with surface modification for H2/Br2 fuel cell. Journal of Power Sources 2013, 242, 15-22.

36. Kim, K. J.; Lee, S.-W.; Yim, T.; Kim, J.-G.; Choi, J. W.; Kim, J. H.; Park, M.-S.; Kim, Y.-J., A new strategy for integrating abundant oxygen functional groups into carbon felt electrode for vanadium redox flow batteries. Scientific Reports 2014, 4, 6906.

37. Shi, L.; Liu, S.; He, Z.; Yuan, H.; Shen, J., Synthesis of boron and nitrogen co-doped carbon nanofiber as efficient metal-free electrocatalyst for the VO2+/VO2+ Redox Reaction. Electrochimica Acta 2015, 178, 748-757.

38. Jin, J.; Fu, X.; Liu, Q.; Liu, Y.; Wei, Z.; Niu, K.; Zhang, J., Identifying the active site in nitrogen-doped graphene for the VO2+/VO2+ redox reaction. Acs Nano 2013, 7 (6), 4764-4773.

39. Aaron, D.; Tang, Z.; Papandrew, A. B.; Zawodzinski, T. A., Polarization curve analysis of all-vanadium redox flow batteries. Journal of Applied Electrochemistry 2011, 41 (10), 1175.

40. Zhang, H.; Zhang, H.; Zhang, F.; Li, X.; Li, Y.; Vankelecom, I., Advanced charged membranes with highly symmetric spongy structures for vanadium flow battery application. Energy & Environmental Science 2013, 6 (3), 776-781.

41. Lawton, J. S.; Jones, A.; Zawodzinski, T., Concentration dependence of VO2+ crossover of nafion for vanadium redox flow batteries. Journal of The Electrochemical Society 2013, 160 (4), A697-A702.

42. Mukhopadhyay, A.; Hamel, J.; Katahira, R.; Zhu, H., Metal-free aqueous flow battery with novel ultrafiltered lignin from wood as electrolyte. ACS Sustainable Chemistry & Engineering 2018.

43. Lehtinen, P.; Foster, A. S.; Ayuela, A.; Krasheninnikov, A.; Nordlund, K.; Nieminen, R. M., Magnetic properties and diffusion of adatoms on a graphene sheet. Physical review letters 2003, 91 (1), 017202.

44. Krasheninnikov, A.; Lehtinen, P.; Foster, A. S.; Pyykkö, P.; Nieminen, R. M., Embedding transition-metal atoms in graphene: structure, bonding, and magnetism. Physical review letters 2009, 102 (12), 126807.

45. Kresse, G.; Joubert, D., From ultrasoft pseudopotentials to the projector augmented-wave method. Physical Review B 1999, 59 (3), 1758.

46. Blöchl, P. E., Projector augmented-wave method. Physical review B 1994, 50 (24), 17953.

47. Kresse, G.; Furthmüller, J., Efficient iterative schemes for ab initio total-energy calculations using a plane-wave basis set. Physical review B 1996, 54 (16), 11169.

48. Perdew, J. P.; Burke, K.; Ernzerhof, M., Generalized gradient approximation made simple. Physical review letters 1996, 77 (18), 3865.

### INCORPORATION BY REFERENCE; EQUIVALENTS

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A method for exfoliating a graphite felt, the method comprising:
applying a voltage differential to the graphite felt in an aqueous solution, wherein:
the voltage differential is from about 5 V to about 20 V;
the voltage differential is applied for a duration from about 15 seconds to about 10 minutes; and
the aqueous solution comprises a dissolved electrolyte,
thereby forming an exfoliated graphite felt.

2. The method of claim 1, wherein the dissolved electrolyte comprises SO₄²− ions.

3. The method of claim 1, wherein the dissolved electrolyte comprises NH₄⁻ ions.

4. The method of claim 1, wherein the dissolved electrolyte comprises SO₄²⁻ ions and NH₄⁺ ions.

5. The method of claim 1, further comprising dissolving ammonium sulfate (((NH)₄)₂SO₄) to form the dissolved electrolyte.

6. The method of claim 5, wherein the concentration of dissolved ammonium sulfate is from about 0.1 M to about 0.5 M.

5. The method of claim 5, wherein the concentration of dissolved ammonium sulfate is about 0.1 M.

8. The method of claim 1, wherein the dissolved electrolyte comprises one or more of NO₃⁻ ions, SO₃²⁻ ions, and CO₃²⁻ ions.

9. The method of claim 1, wherein the method further comprises dissolving one or more of (NH₄)₂SO₃, Na₂CO₃, NaNO₃.

10. The method of claim 1, wherein the voltage differential is from about 10 V to about 15 V.

11. (canceled)

12. The method of claim 1, wherein the voltage differential is applied for a duration from about 30 seconds to 4 minutes.

13. The method of claim 1, wherein the voltage differential is applied for a duration from about 30 seconds to 2 minutes.

14-16. (canceled)

17. The method of claim 1, wherein applying a voltage differential to the graphite felt comprises applying the voltage differential to a roller that contacts the graphite felt.

18. The method of claim 1, wherein the exfoliated graphite felt exhibits an aqueous contact angle from about 0 degrees to about 10 degrees.

19. The method of claim 1, wherein the exfoliated graphite felt has a surface oxygen content of at least 20% as determined by X-ray photoelectron spectroscopy.

20. The method of claim 1, wherein the exfoliated graphite felt has a surface oxygen content from about 20% to about 25% as determined by X-ray photoelectron spectroscopy.

21. The method of claim 1, wherein the exfoliated graphite felt has an oxygen-to-carbon ratio of at least 0.3 as determined by X-ray photoelectron spectroscopy.

22. The method of claim 1, wherein the exfoliated graphite felt has an oxygen-to-carbon ratio from 0.25 to 0.375 as determined by X-ray photoelectron spectroscopy.

23. A graphite felt having a surface oxygen content of at least 20% as determined by X-ray photoelectron spectroscopy.

24. (canceled)

25. A flow battery comprising an electrode, an electrolyte, and a battery, wherein the electrode comprises an exfoliated graphite felt formed according to the method of claim 1.
